(19) United States
(12) Patent Application Publication
(10) Pub. No.: US 2018/0133628 A1
(43) Pub. Date: May 17, 2018

(54) SEPARATION APPARATUS AND METHOD

(71) Applicant: Z-FILTER PTY LTD, Canning Vale, West Australia (AU)

(72) Inventors: Neil Deryck Bray Graham, Canning Vale (AU); Arthur Derrick Bray GRAHAM, Mosman Park (AU); Bradley James COLE, Atwell (AU); Jamie KERKHOFF, Scarborough (AU)

(21) Appl. No.: 14/434,995

(22) PCT Filed: Oct. 10, 2013
(86) PCT No.: PCT/AU13/01173

§ 371 Date: Jun. 29, 2017

(30) Foreign Application Priority Data
Oct. 10, 2012 (AU) 2012904430

(51) Int. Cl. B01D 33/52; B01D 33/04; B01D 33/056; B01D 33/64; C02F 11/12; B01D 35/22

(52) U.S. Cl. CPC B01D 33/52; B01D 33/042; B01D 33/0565; C02F 2201/008; C02F 11/123; B01D 35/22; B01D 33/646

(57) ABSTRACT

An apparatus for performing an operation on a fluid material to separate liquid from solid matter within the fluid material The apparatus comprises a belt structure movable along a path. The belt structure comprises a belt portion adapted to be assembled into a movable tubular structure within which at least part of the operation is to be performed. The tubular structure is permeable to liquid for separation of liquid from solid matter within the fluid material. The tubular structure is continuously assembled at one end thereof and continuously disassembled at another end thereof during movement of the belt structure. The path includes a descending portion along which the assembled tubular structure passes, the descending portion being inclined whereby at least some of the solid matter within fluid material in the tubular structure is caused to move downwardly along the descending portion under the influence of gravity to facilitate cleaning of the permeable tubular structure.

### TECHNICAL FIELD

This invention relates to treatment of heterogeneous mixtures comprising solid and liquid phases. More particularly, the invention relates to the treatment of heterogeneous mixtures to separate solid and liquid phases.

Specifically, the invention is concerned with apparatus for removal of liquids from solids in fluid material, and to a method of removal of liquids from solids in fluid material.

In the context of this specification, the term fluid material refers to material in the form of a heterogeneous mixture which has both liquid and solids components and which is capable of flow. Typically, the fluid material is pumpable, although not necessarily so.

The fluid material may comprise a fluid mixture comprising particulate or pulverised solids and liquid. Typically the fluid material comprises slurry.

The liquid may comprise a single liquid or a mixture of two or liquids.

Where the separation involves separation of solids from liquid, it is likely that the separation will not he complete: that is, the separated solids will likely be contaminated with some liquid, and the liquid from which the solids have been separated will likely contain some remnant solids.

The apparatus has been devised particularly, although not solely, for dewatering a water laden sludge such as, for example, water-laden sewage including animal and human sewage, mining concentrates, mining wastes, ores, coal fines, tailings, wood pulp, paper pulp, agricultural products, food products including milk and cheese, wine grape mash/pulp, dyes for plastics and paints, bio pellets, as well as separation of clays for brick manufacture and fines for concrete, water filtration, and filtration for aquaculture.

### BACKGROUND ART

The following discussion of the background art is intended to facilitate an understanding of the present invention only. The discussion is not an acknowledgement or admission that any of the material referred to is or was part of the common general knowledge as at the priority date of the application.

In the WO 2007/143780, the present applicant disclosed a belt filter apparatus for treating sludge material such as sewage for the purposes of dewatering the sludge material to facilitate recovery of the solid matter for subsequent treatment The belt filter apparatus incorporated an endless belt structure comprising an elongate belt portion formed of liquid permeable material. For certain sludge materials, it has been found that there is a tendency for the solid particulates to block the liquid permeable material and thereby reduce the effectiveness of the separation process. In other words, the belt portion can become blinded by the accumulation of solid particulates.

It is against this background that certain aspects of the present invention have been developed.

### SUMMARY OF INVENTION

Certain aspects of the present invention stem from the realization that solid particulates can be mobilized to facilitate removal of accumulated material which might otherwise lead to blinding of a filter apparatus.

According to a first aspect of the invention there is provided an apparatus for performing an operation on a fluid material to separate liquid from solid matter within the fluid material, the apparatus comprising a belt structure movable along a path, the belt structure comprising a belt portion adapted to be assembled into a movable tubular structure within which at least part of the operation is to be performed, the tubular structure being permeable to liquid for separation of liquid from solid matter within the fluid material, the tubular structure being continuously assembled at one end thereof and continuously disassembled at another end thereof during movement of the belt structure, the path including a descending portion along which the assembled tubular structure passes, the descending portion being inclined whereby at least some of the solid matter within fluid material in the tubular structure is caused to move downwardly alone the descending portion under the influence of gravity to facilitate cleaning of the permeable tubular structure.

With this arrangement, the permeable tubular structure provides a selective barrier through which liquid can pass but through which at least some of the solid matter cannot pass.

Where the solid matter comprises solid particulate matter, particulate solids of a size which can pass through the barrier are hereinafter referred to as undersize solids and particulate solids which cannot, pass through the barrier are hereinafter referred to as oversize solids.

It is likely that the separation will not be entirely complete; that is, the separated solids will likely be contaminated with sonic liquid, and the liquid from which the solids have been separated will likely contain some remnant solids. Typically undersize solids.

The cleaning of the tubular structure may comprise removal of accumulated solid matter to prevent or at least reduce blinding of the permeable tubular structure.

With this arrangement, particulate solids are mobilized in the descending portion of the permeable tubular structure, serving to scour the surface of the tubular structure to remove accumulated material which might otherwise lead to blinding of the tubular structure and a resultant loss of, or reduction in, its permeability.

The scouring action developed by the mobilized particulate solids may comprise removal of accumulated material by frictional effects on the accumulated material and/or hydrodynamic forces developed in the liquid within the tubular structure through movement of the particulate solids.

With the fluid material flowing downwardly within the tubular structure under the influence of gravity, any agglomerated particulate solids within the fluid material are influenced to separate from the agglomerated state, establishing flow paths to facilitate release of liquid from within the agglomerated matter. The released liquid can discharge from the permeable tubular structure and the freed particulate solids can tumble down the sloping descending portion, further facilitating the scouring action. It is believed that this action is likely to be more effective in separating liquid from the particulate solids than compressing the fluid material at this stage, as the latter action of compressing the fluid material would likely tend to close off flow paths and trap liquid between particulate solids.

The tubular structure may be permeable in any appropriate way. Typically, the tubular structure may be permeable by virtue of the material from which the belt portion is made. In particular, the belt portion may comprise material which is permeable. In other words, the belt portion may be formed of material which is permeable to the liquid concerned, whereby liquid can flow laterally through the tubular structure under the influence of gravity. The belt portion may be made entirely of such permeable material, or one or more sections of the belt portion may comprise such permeable material. Typically, the belt portion is formed entirely of such permeable material. However, in an alternative arrangement the belt portion may be only partly formed of such material; for example, the be portion may comprise a longitudinal section formed of such permeable material, with the longitudinal section being so disposed with respect to the remainder of the belt structure that is lowermost when the assembled tubular structure passes along the descending portion.

By way of example, the elongate belt portion may be formed of fluid permeable sheet material, such a flexible filter pad material such as woven polypropylene. In an embodiment which involves dewatering sludge material, the elongate belt portion may be formed of water permeable sheet material.

Preferably, the belt portion has longitudinal edges adapted to be connected together to assemble the movable tubular structure. More particularly, the belt portion may comprise one or more elongate sheets adapted to be releasably connected together along longitudinal edges thereof to assemble the movable tubular structure. Where the belt portion comprises a single elongate sheet, the latter may be connected along its two opposed longitudinal edges to form the tubular structure. Where the belt portion comprises more than one elongate sheet, the sheets may be connected one to another with two of the sheets being unconnected so that each presents a longitudinal edge, whereby the respective longitudinal edges of the two sheets can be connected together to assemble the tubular structure.

Preferably, the one or more elongate sheets are adapted to be releasably connected along longitudinal edges thereof by a slidable connector means such as a zipper. A particularly suitable slider connector means is of the type disclosed in U.S. Pat. No. 6,467,136 in the name of Neil Deryck Bray Graham, the contents of which are incorporated herein by way of reference.

The slidable connector means may comprise two connector elements adapted to interact with each other to provide a connection therebetween. Each connector element may present a contact face, and also ridges and recesses arranged to interact with each other. The two connector elements may be substantially identical in construction and configured for mating engagement.

Preferably, the belt structure further comprises two funicular elements connected to the belt portion, the funicular elements being adapted to support the belt portion therebetween.

Preferably, the funicular elements not only support the belt portion therebetween but also guide and drive the belt structure along the path.

Preferably, the belt structure comprises an endless belt structure and the path comprises an endless path about which the endless belt structure circulates.

Preferably, the endless path incorporates guide roller structures around which the belt structure passes with the funicular elements in engagement with the guide roller structures.

Preferably, the guide roller structures are configured to guidingly receive the funicular elements. With this arrangement, the assembled tubular structure is guided along the path, in particular, the arrangement serves to hold the funicular elements apart at stages where the tubular structure is subjected to compression. This is to ensure that the compressed tubular structure maintains a taut condition without folds, creases and wrinkles. The presence of folds, creases or wrinkles can be problematic in relation to uniform compression of the confined material and may also lead to damage to the belt portion as a result of misalignment and excessive crushing forces over the folds.

The funicular elements may be of any appropriate form, such as, for example, endless elements configured as bolt ropes, cables, drive transmission belts or drive transmission chains. Further, each funicular element may comprise a single endless element, or two or more endless elements in side-by-side relation. For example, each funicular element may comprise several drive transmission belts positioned in side-by-side relation and connected together to function as a unit.

Typically, the tubular structure is configured to define a single interior compartment along which at least part of the operation is to be performed. For certain applications, the tubular structure may, however, be configured to define a plurality of interior compartments along which at least part of the operation is to be performed. With such an arrangement, the plurality of interior compartments would typically be disposed in side-by-side relation and extend the full length of the assembled tubular structure. This arrangement may be particularly suitable for a tubular structure which is relatively large in size.

There may be further funicular elements connected to the belt portion. Typically, the further funicular elements would assist in providing support for the belt portion, as well as providing guidance and drive to the belt structure along the path. This arrangement may be particularly suitable for a tubular structure which is relatively large in size, including in particular one in which the tubular structure is configured to define a plurality of interior compartments.

Each guide roller structure may take any appropriate form. In one arrangement, each guide roller structure may comprise two wheels each having an outer periphery configured to guidingly receive a respective one of the funicular elements. With this arrangement, the assembled tubular structure is guided along the path. In particular, the arrangement serves to hold the funicular elements apart at stages where the tubular structure is subjected to compression, as mentioned above.

The two wheels which together constitute the guide roger structure may be mounted on separate axes or on a common axle. When the two wheels are mounted on a common axle, the latter may serve to mechanically link the wheels together for rotation in unison, although this need not necessarily be so.

Where appropriate, the two wheels may be in a spaced part relation defining a space therebetween of a size sufficient to allow the assembled tubular structure to advance along a path defined between the two wheels.

In the arrangement where the funicular elements comprise ropes or cables, the outer periphery of each wheel may be configured as a rim having a peripheral groove for receiving a respective one of the funicular elements. In the arrangement where the funicular elements comprise drive transmission chains, the wheels may comprise sprockets having teeth at their outer peripheries for engaging the chains. In the arrangement where the funicular elements comprise perforated drive belts, the wheels may comprise sprockets having teeth at their outer peripheries for engaging the perforations within the drive belts. In the arrangement where the funicular elements comprise toothed drive, belts, the wheels may comprise sprockets having their outer peripheries configured for meshing engaging the tooth formations on the drive belts.

Preferably, the apparatus further comprises means for introducing fluid material on which an operation is to be performed into the tubular structure.

Preferably, the delivery of fluid material into the tubular structure is controlled such that the tubular structure does not completely fill while performing the operation. Rather, the delivery is controlled to allow fluid flow downwardly along at least a section, preferably an upper section of the inclined descending portion thereby encouraging solids to move downwardly along the descending portion under the influence of gravity to establish relative movement between the solids within the tubular structure and the tubular structure itself to facilitate cleaning of the permeable tubular structure.

Preferably, the descending portion of the path along which the assembled tubular structure passes is configured to provide support for the inclined descending portion of the tubular structure advancing there along.

Preferably, the support is configured to cause disturbance of material flow within the tubular structure and to also spreading of the material within the tubular structure. More particularly, the support is preferably configured to create turbulence in the downwards flow and spread the flow to optimise the area within the tubular structure being utilised thereby to allow the scouring process to occur and also optimise the area over which liquid can leave the tubular structure.

The support may be provided by at least support element over which the tubular structure travels, and preferably a series of support elements located at intervals along the descending portion of the path. The support element may be of any appropriate form, such as a roller, bar or other arrangement. Typically, the support elements act to establish raised sections within the bottom of the tubular structure constituting a bed over which the material flows.

Typically, the flow of fluid material along the inclined descending portion of the tubular structure slows towards the bottom end thereof, leading to an accumulation of solids in the bottom section. The accumulation of solids in the bottom section establishes a blockage which also assists in slowing liquid flow within the tubular structure, thereby increasing its residence time during which liquid can drain from the tubular structure.

The slowing of the flow may occur because of increased friction arising from the loss of liquid, the friction being between particulate solids, and also between the particulate solids and the surface of the tubular structure. As the flow slows, the particulate solids commence to agglomerate, leading to caking and also progressive thickening of the cake, with the progressively developing caked mass rolling or tumbling down the inclined descending portion of the tubular structure.

Preferably, the path at the bottom of the descending portion along which the assembled tubular structure passes includes a turn section configured to propagate radial expansion and contraction of successive sections of the tubular structure as it advances about the turn section, thereby assisting to convey the agglomerated material within the tubular structure around the turn section.

With this arrangement, the agglomerated material within the tubular structure is transported around the turn section without being subjected to compaction.

Preferably, the turn section is defined by a turn roller structure having an outer periphery about which the tubular structure passes, the outer periphery comprising a plurality of circumferentially spaced portions with intervening cavities therebetween. With this arrangement, the circumferentially spaced portions cause contraction of successive sections of the tubular structure as it advances about the turn section and the intervening cavities accommodate corresponding radial expansion of successive sections of the tubular structure.

This action is somewhat akin to a peristaltic action in that there is radial contraction and radial expansion of successive sections of the tubular structure, although the material is not pumped along the tubular structure. Rather, the material continues to advance and move upwards with the tubular structure (instead of falling down the tubular structure after having passed through the turn section), the radial expansion merely accommodating material displaced as a result of the radial contraction arising from engagement with the turn roller structure.

In one arrangement, the outer periphery is defined by a plurality of circumferentially spaced elements, with spacing therebetween defining the cavities

The turn roller structure may be of squirrel cage configuration to provide the outer periphery comprising the plurality of circumferentially spaced elements with cavities therebetween.

In another arrangement, the turn roller structure may be configured to present a plurality of roller elements to the turning tubular structure, with roller elements being disposed in circumferentially spaced relation and rotating independently of the speed of movement of the tubular structure.

Preferably, the apparatus further comprises press means for pressing the tubular structure along a portion thereof. This may be for the purpose of expressing liquid from material contained within that portion of the tubular structure being subjected to a pressing action.

The press means may perform a compacting action on material contained within that portion of the tubular structure, or a compressing action on material contained within that portion of the tubular structure, or both a compacting action and a compressing action thereon.

In one arrangement, the press means may comprise a confined and tortuous section of the path along which the tubular structure passes. The confined and tortuous section of the path may be defined by and between press rollers disposed on opposed sides of the path.

In another arrangement, the compression means may comprise a press for mechanically compressing the tubular structure. The press may be located at a pressing station at which a pressing action is applied to that portion of the tubular structure passing therethrough to squeeze the tubular structure and thus extract remnant liquid from the material contained therein.

The press may comprise two press portions disposed in opposed, spaced apart relation to define a pressing zone through which the tubular structure can pass. Typically, the tubular structure is drawn through the pressing zone between the two press portions, with the opposed press portions exerting a pressing action on the tubular structure as it is drawn though the pressing zone.

The pressing zone between the two press portions may contract in the direction of travel of the tubular structure through the pressing zone so as to increase the pressing action on the tubular structure as it advances through the pressing zone. The contraction may be for the entire pressing zone, or for only a section of the pressing zone. Preferably, the two press portions contract progressively in the direction of travel of the tubular structure through the pressing zone so as to progressively increase the pressing action on the tubular structure as it advances through the pressing zone. Typically, the press portions define press faces which taper towards each other in the direction of intended movement of the tubular structure through the pressing zone.

With this arrangement, the pressing action comprises a reactionary pressing action in the sense that the two press portions do not undergo movement with respect to each other to effect the pressing action, but rather the pressing action arises from interaction between the two press portions and the portion of the tubular structure being compressed as it passes through the pressing zone defined between the two press portions. In other words, the reaction of the tubular structure acting on each press portion as the tubular structure moves through the narrowing pressing zone exerts the compressive force on the tubular structure.

The press portions may comprise platens defining press surfaces in opposed relation for exerting a pressing action on the tubular structure as it is drawn through the pressing zone. The press surfaces, or at least one of the press surfaces, may be perforated or otherwise configured to allow liquid extracted as a result of the pressing action to flow away from the press zone. The platens may be made of low friction material to facilitate sliding movement of the tubular structure in a compressed condition as it passes through the pressing zone. The low friction material may be of any suitable type, such as a thermoplastic polyethylene. Ultra-high-molecular-weight polyethylene (UHMWPE) is believed to be particularly suitable, owing to its low coefficient of friction, resistance to abrasion, self-lubricating nature, and high resistance to most corrosive chemicals.

The press portions may alternatively be defined by two cyclically movable structures each having an inner run and an outer run, with the two cyclically movable structures being so positioned that the two in runs comprise the press portions. The cyclically moveable structures may comprise two endless bands disposed in spaced apart relation with the inner runs cooperating to subject the tubular structure to a compressive action. The cyclically movable structures, or at least one of the cyclically movable structures, may be perforated or otherwise configured to allow liquid extracted as a result of the pressing action to flow away from the press zone. By way of example, each endless band may formed of mesh material, with pores in the mesh providing perforations to allow liquid extracted as a result of the pressing action to flow away from the press zone.

The press portions may further alternatively be defined by a plurality of spaced parts press elements arranged in two sets, with one set defining one of the press portions and the other set defining the other press portion. The spaced apart press elements in each set are preferably aligned so as to cooperate to define a pressing face. With this arrangement, the two sets of press elements define two opposed pressing faces between which the pressing zone is defined. Each pressing face is not continuous, but rather is discontinuous in that it is defined by the respective press elements, with the intervening spacings proving discontinuities in the pressing face.

The tubular structure may be subjected to a compression as it undergoes deflection in passing around one or more of the guide roller structures.

Further, the tubular structure may undergo compression as a result of tension which is exerted on the tubular structure by virtue of axial tension on the belt portion and also tension arising from the loading exerted by material contained within the tubular structure. Such compression may assist in squeezing liquid from the material.

Any one of, or any combination of, the above may be utilised for compressing the tubular structure.

Preferably a liquid removal system is provided to engage the exterior of the tubular structure to cause liquid adhering thereto to be released. The liquid removal system may comprise one or more wipers or scrapers. The scrapers may comprise plastic scraper blades.

The liquid removal system is preferably disposed after the turn section. Typically, the liquid removal system is disposed along or prior to the tortuous section of the path along which the tubular structure passes.

Preferably, the apparatus further includes separating means for longitudinally splitting the tubular structure for discharge of matter contained therein. Such longitudinal splitting may comprise disassembly of the tubular structure.

Typically, material discharges from the belt portion after longitudinal splitting of the tubular structure by falling from the belt portion under the influence of gravity.

Removal means may be provided for removing remnant matter from the belt portion after splitting of the tubular structure. The removal means may subject the belt portion to a cleaning action which may involve scraping, washing, application of a cleaning fluid (liquid or gas) under pressure, suction or any combination of such actions.

Preferably, the tubular structure is open at the assembly end thereof to receive the material on which the operation is to be performed.

The apparatus according to the invention may be of a configuration and size to facilitate transportation to and from a site of intended use and to be manoeuvred around the site.

The apparatus may be configured to provide a single tubular structure or a plurality of tubular structures. In the latter case, the plurality of tubular structures may be operable in side-by-side parallel relation.

Where the apparatus provides a plurality of tubular structures operable in side-by-side parallel relation, there may be a plurality of belt portions each adapted to be assembled into a respective one of the tubular structures.

Preferably, each belt portion is connected to and supported between two funicular elements.

In one arrangement, the belt portions may be connected one to another to provide a common assembly. With this arrangement, adjacent belt portions may share a common funicular element disposed therebetween.

In another arrangement, the belt portions may be exist separately of each other, with each belt portion supported between discrete funicular elements. This arrangement is advantageous in that it facilitates replacement of :any one of the belt portions without necessitating replacement of other belt potions at the same time.

In yet another arrangement, multiple belt portions may be connected one to another to provide a common assembly, with there being a plurality of the multiple assemblies. In other words, belt portions in each multiple assembly are connected one to another, but the multiple assemblies are not connected one to another. This arrangement facilitates replacement of any one of the multiple assemblies without necessitating replacement of other the multiple assemblies at the same time.

The use of apparatus configured to provide a plurality of tubular structures may be advantageous in certain circumstances. By way of example, such apparatus may offer large areas for processing with opening and closing areas that are relatively small. This is due to the length relationship between a narrow tubular structure and a wide tubular structure. With a wide tubular structure there is a requirement for a disproportionately long length to open and dose the tubular structure. In contrast, a series of relatively narrow tubular structures operating in concert only requires the same length as any one of the component small tubular structures within the series to open and close the tubular structure. This provides packaging advantages that are not available with a large tubular structure.

Preferably, a slider is operable in conjunction with the two connector elements to move them together into engagement as the endless belt circulates around path. Typically, the slider is fixed and the two connector elements move relative to the slider.

The slider may comprise an alignment mechanism.

The alignment mechanism may comprise a body having two passages, each configured to receive one of the connector elements. The two passages may be disposed to align the connector elements in preparation for them being brought together into a interconnected condition. Typically, the two passages are disposed on opposed sides of the body, one above the other in order to align the connector elements in preparation for being brought together into the interconnected condition. Each passage may have an outer longitudinal side which opens onto the respective side of the body and a closed inner longitudinal side. Each passage is of a cross-sectional configuration which is a counterpart to the cross-sectional profile of the respective the connector element. Each passage may include recesses and ribs which mate with the respective ridges and recesses on the respective connector element. In this way, the connector elements may be captivley guided along the passages and maintained in alignment in readiness to be later brought together into the interconnected condition, as will be explained in more detail shortly.

The body may have provision for lubricating the connector elements before they are brought together in to the interconnected condition. The lubricant is applied to the contact face, ridges and recesses of at least one, and preferably both, of the connector element passing along the passages.

The alignment mechanism may further comprise a guide element adjacent the entry end of each passage for guiding the respective connector element into an entry position as it approaches the passage.

The slider may comprise closure mechanism for urging the aligned connector elements into the interconnected condition after they have moved out of the passages in the alignment mechanism. Once the connector elements have moved out of the passages, they may be so disposed one with respect to the other such that the contact faces are in face-to-face relation and the respective ridges and recesses are in alignment for registration with each other. The closure mechanism operates to press the two connector elements into registration with each other to assume the interconnected condition, as will be explained below.

The closure mechanism may comprises two press rollers so positioned that the aligned connector elements pass between the two press rollers and are pressed into registration with each other to assume the interconnected condition.

The two press rollers may be yieldingly biased towards each other. In particular, the press rollers may comprise a fixed roller and a floating roller yielding movable with respect to the fixed roller. The fixed roller may be mounted on a fixed arm and the floating roller may be mounted on a swing arm. A biasing mechanism may bias the swing arm towards fixed arm, thereby to biasing the floating roller towards the fixed roller. The biasing mechanism may be selectively adjustable for varying the compressible force which can be exerted by the cooperating press rollers to press the aligned connector element into registration with each other to assume the interconnected condition.

According to a second aspect of the invention there is provided a method of removal of liquids from solids in fluid material, the method comprising use of apparatus according to the first aspect of the invention.

According to a third aspect of the invention there is provided a method of removal of liquids from solids in fluid material, the method comprising assembling a movable tubular structure within which at least part of the removal operation is to be performed, the tubular structure being permeable to the liquid, moving the tubular structure along a path including a descending portion, introducing the fluid material into the tubular structure whereby the fluid material flows down the descending portion, the descending portion being inclined whereby at least some of the solid matter is caused to move downwardly along the descending portion under the influence of gravity to facilitate cleaning of the permeable tubular structure.

Preferably, the method further comprises subjecting the tubular structure to a pressing action along a portion of the path after the descending portion. This may be for the purpose of expressing liquid from material contained within that portion of the tubular structure being subjected to the pressing action.

Preferably, the method further comprises longitudinally splitting the tubular structure for discharge of matter contained therein. Such longitudinal splitting may comprise disassembly of the tubular structure.

Preferably, the method further comprises discharging material from the belt portion after longitudinal splitting of the tubular structure.

Preferably, the material is discharged by allowing it to fall from the belt portion under the influence of gravity.

The discharge of material may be assisted by subjecting the belt portion to a cleaning action. The cleaning action may involve scraping, washing, application of a cleaning fluid (liquid or gas) under pressure, suction or any combination of such actions.

Preferably, fluid material is introduced into the tubular structure at the assembly end thereof which defines an opening to receive the fluid material.

Preferably, the delivery of fluid material into the tubular structure is controlled such that the tubular structure does not completely fill while performing the operation. Rather, the delivery is controlled to allow fluid flow downwardly along at least a section, preferably an upper section, of the inclined descending portion thereby encouraging solids to move downwardly along the descending portion under the influence of gravity to establish relative movement between the solids within the tubular structure and the tubular structure itself to facilitate cleaning of the permeable tubular structure.

Preferably, the method further comprises supporting the inclined descending portion of the tubular structure.

Preferably, the support is rendered in a manner to disturb material flow within the tubular structure and to also spread the material within the tubular structure. More particularly, the support is preferably is rendered in a manner to create turbulence in the downwards flow and spread the flow to optimise the area within the tubular structure being utilised thereby to allow the scouring process to utilised to allow the scouring process to occur and also optimise the area over which liquid can leave the tubular structure.

According to a fourth aspect of the invention there is provided an apparatus for performing an operation on a fluid material to separate liquid from solid matter within the fluid material, the apparatus comprising a belt structure movable along a path, the belt structure comprising a belt portion adapted to be assembled into a movable tubular structure within which at least part of the operation is to be performed, the tubular structure being permeable to liquid for separation of liquid from solid matter within the fluid material, the tubular structure being continuously assembled at one end thereof and continuously disassembled at another end thereof during movement of the belt structure, the path including a descending portion along which the assembled tubular structure passes, the path further including a turn section at the bottom of the descending portion, and compression means for compressing the tubular structure along a portion thereof after the turn section.

Preferably, the path further includes an ascending portion, the compression means being provided along the ascending portion.

Preferably, the turn section is configured to propagate radial expansion and contraction of successive sections of the tubular structure as it advances about the turn section, thereby assisting to convey the agglomerated material within the tubular structure around the turn section.

With this arrangement, the agglomerated material within the tubular structure is transported an and the turn section without being subjected to compaction.

According to a fifth aspect of the invention there is provided an apparatus for performing an operation on a fluid material to separate liquid from solid matter within the fluid material, the apparatus comprising a belt structure movable along a path, the belt structure comprising a belt portion adapted to be assembled into a movable tubular structure within which at least part of the operation is to be performed, the tubular structure being permeable to liquid for separation of liquid from solid matter within the fluid material, the tubular structure being continuously assembled at one end thereof and continuously disassembled at another end thereof during movement of the belt structure, the path including a descending portion along which the assembled tubular structure passes, the descending portion being configured to provide support for the portion of the tubular structure advancing therealong, the support being configured to cause disturbance of material flow within the tubular structure and to also spreading of the material within the tubular structure.

In this fifth embodiment, the support may be provided by at least support element over which the tubular structure travels, and preferably a series of support elements located at intervals along the descending portion of the path. The support element may be of any appropriate form, such as a roller, bar or other arrangement. Typically, the support elements act to establish raised sections within the bottom of the tubular structure constituting a bed over which the material flows.

In the fourth and fifth aspects of the invention, the descending portion may be inclined whereby at least some of the solid matter within fluid material in the tubular structure is caused to move downwardly along the descending portion under the influence of gravity to facilitate cleaning of the permeable tubular structure.

According to a sixth aspect of the invention there is provided an apparatus for performing an operation on a fluid material to separate liquid from solid matter within the fluid material, the apparatus comprising a belt structure movable along a path, the belt structure comprising a belt portion adapted to he assembled into a movable tubular structure, within which at least part of the operation is to be performed, the tubular structure being permeable to liquid for separation of liquid from solid matter within the fluid material, the tubular structure being continuously assembled at one end thereof and continuously disassembled at another end thereof during movement of the belt structure, the belt portion having longitudinal edges adapted to he connected together by a slidable connector means to assemble the movable tubular structure, the slidable connector means comprising two connector elements adapted to interact with each other to provide a connection therebetween, and a slider operable in conjunction with the two connector elements to move them together into engagement as the endless beg circulates around path, the slider comprising a body having two passages each configured to receive one of the connector elements, the two passages being disposed to align the connector elements in preparation for them being brought together into a interconnected condition.

The slider may have any one or more of the features referred to above.

In particular, the body may have any one or more of the features referred to above, including provision for lubricating the connector elements before they are brought together in to the interconnected condition.

Further, the slider may comprise a closure mechanism for urging the aligned connector element into the interconnected condition after they have moved out of the passages in the alignment mechanism. The closure mechanism may have any one or more of the features referred to above.

According to a seventh aspect of the invention there is provided en apparatus for performing an operation on a material, the apparatus comprising a belt structure movable along a path, the belt structure comprising a belt portion adapted to be assembled into a movable tubular structure within which at least part of the operation is to be performed, the tubular structure being continuously assembled at one end thereof and continuously disassembled at another end thereof during movement of the belt structure, the belt portion having longitudinal edges adapted to be connected together by a slidable connector means to assemble the movable tubular structure, the slidable connector means comprising two connector elements adapted to interact with each other to provide a connection therebetween, and a slider operable in con unction with the two connector elements to move them together into engagement as the endless belt circulates around path, the slider comprising a body having two passages each configured to receive one of the connector elements, the two passages being disposed to align the connector elements in preparation for them being brought together into a interconnected condition.

In the apparatus according to the seventh aspect of the invention, the slider may have any one or more of the features referred to above in relation to earlier aspects of the invention.

In particular, the body may have any one or more of the features referred to above, including provision for lubricating the connector elements before they are brought together in to the interconnected condition.

Further, the slider may comprise a closure mechanism for urging the aligned connector element into the interconnected condition after they have moved out of the passages in the alignment mechanism. The closure mechanism may have any one or more of the features referred to above.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying depictions (drawings and photographs) in which:

FIG. 1 is a perspective view of a first embodiment of apparatus according to the invention:

FIG. 2 is a schematic side view of the apparatus shown in FIG. 1;

FIG. 3 is a schematic view of a path around which an endless belt structure within the apparatus circulates:

FIG. 4 is a schematic perspective view of the belt structure is the configuration which it has when circulating around the path;

FIG. 5 is a fragmentary perspective view of the endless belt structure;

FIG. 6 is a schematic cross-sectional view of the endless belt structure;

FIG. 7 is a further fragmentary perspective view of the belt structure;

FIG. 8 is a schematic cross-sectional view of the belt structure with longitudinal edges thereof connected together to provide an assembled tubular structure;

FIG. 9 is a schematic cross-sectional view of the belt structure with longitudinal edges thereof unconnected;

FIG. 10 is a fragmentary perspective view of part of the apparatus illustrating in particular a guide roller structure for the belt structure and a slider for operating connector elements for connecting with longitudinal edges of the belt structure together provide the assembled tubular structure;

FIG. 11 is a further fragmentary perspective view of part of the apparatus illustrating in particular a further guide roller structure and the endless belt structure engaging the guide roller structure;

FIG. 12 is a further fragmentary perspective view of part of the apparatus illustrating in particular a scraper system and a washing system for the endless belt structure;

FIG. 13 is a perspective view of a scraper forming part of the arrangement shown in FIG. 12;

FIG. 14 is a fragmentary schematic view of a descending portion of the path shown in FIG. 3, and illustrating the agglomeration of particulate solids;

FIG. 15 is a further fragmentary schematic view of a descending portion of the path shown in FIG. 3, and illustrating the mobilization of particulate solids and the agglomeration of particulate solids into a thickened solids cake at the bottom of the descending portion of the path;

FIG. 16 is a further fragmentary perspective view of part of the apparatus illustrating in particular a support arrangement for the tubular structure travelling along descending portion of the path shown in FIG. 3;

FIG. 17 s a further fragmentary perspective view of part of the apparatus illustrating in particular a further part of the washing system for the endless belt structure:

FIG. 18 is a further fragmentary perspective view of part of the apparatus illustrating in particular a further part of the washing system for washing connector elements forming part of the endless belt structure;

FIG. 19 is a perspective view of the slider depicted in FIG. 10;

FIG. 20 is a sectional view of the slider shown in FIG. 19;

FIG. 21 is a schematic view of a second embodiment of apparatus according to the invention;

FIG. 22 is a schematic view of a third embodiment of apparatus according to the invention;

FIG. 23 is a schematic view of a fourth embodiment of apparatus according to the invention;

FIG. 24 is a fragmentary perspective view of part of the apparatus shown in FIG. 25 illustrating in particular the lower end section of the descending portion of the path around which the endless belt structure circulates;

FIG. 25 is a detail view of part of the arrangement shown in FIG. 24, illustrating in particular two squirrel cage rollers about which the the endless belt structure passes;

FIG. 26 is a fragmentary side view of part of the apparatus shown in FIG. 25 illustrating in particular part of a pressing zone;

FIG. 27 is a fragmentary perspective view of part of the apparatus shown in FIG. 25 illustrating in particular a further part of the pressing zone;

FIG. 28 is a schematic section view of a plurality of tubular structures operable in side-by-side parallel relation for use in a fifth embodiment of apparatus according to the invention;

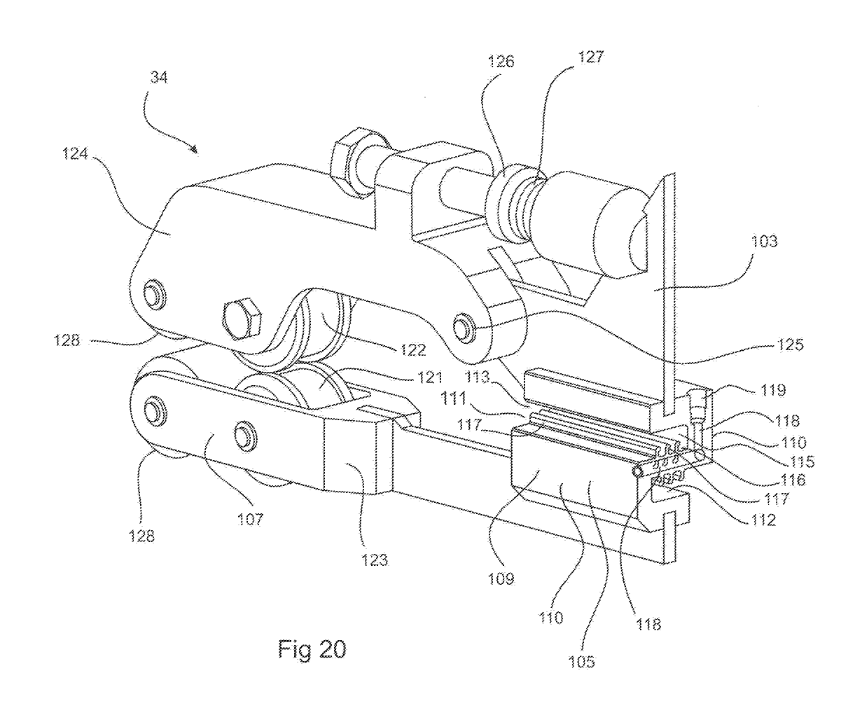

FIG. 20 is a schematic section view of a plurality of tubular structures operable in side-by-side parallel relation for use in a sixth embodiment of apparatus according to the invention; and

FIG. 30 is a schematic fragmentary perspective view of part of a seventh embodiment of apparatus according to the invention.

In the drawings like structures are referred to by like numerals throughout the several views. The drawings shown are not necessarily to scale, with emphasis instead generally being placed upon illustrating the principles of the present invention

### DESCRIPTION OF EMBODIMENTS

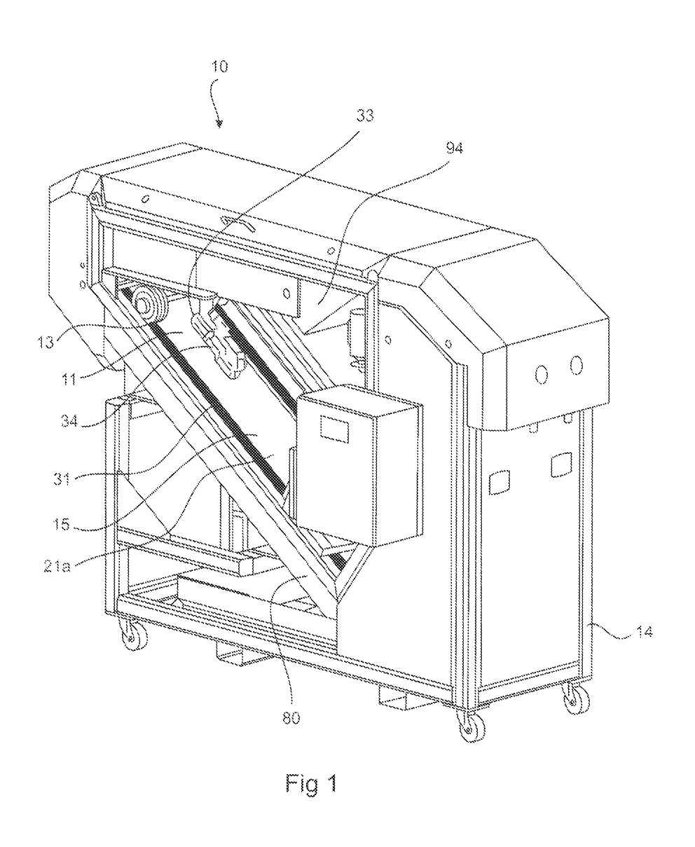

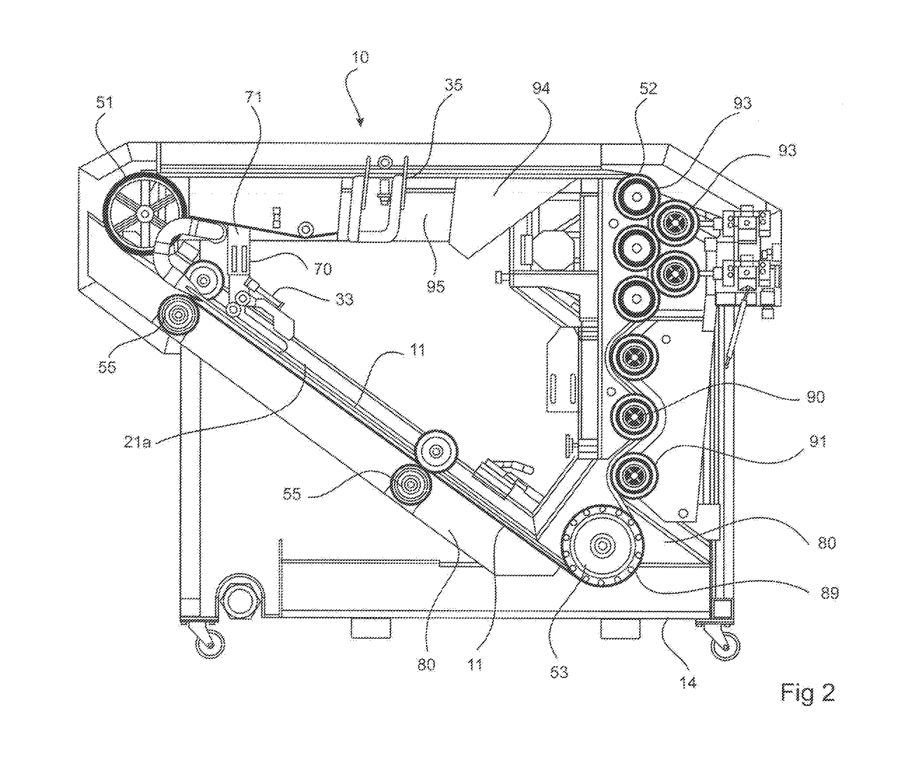

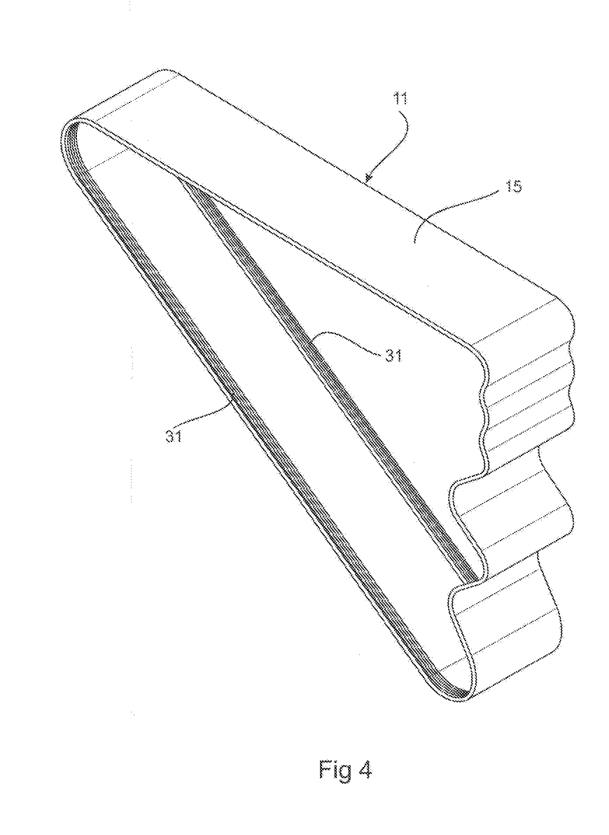

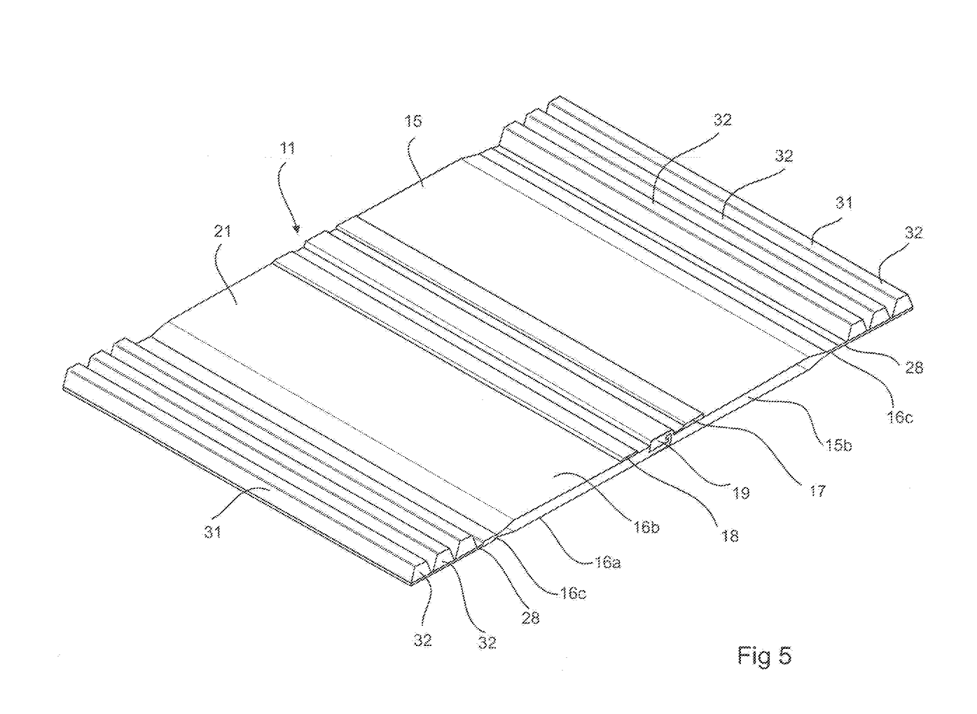

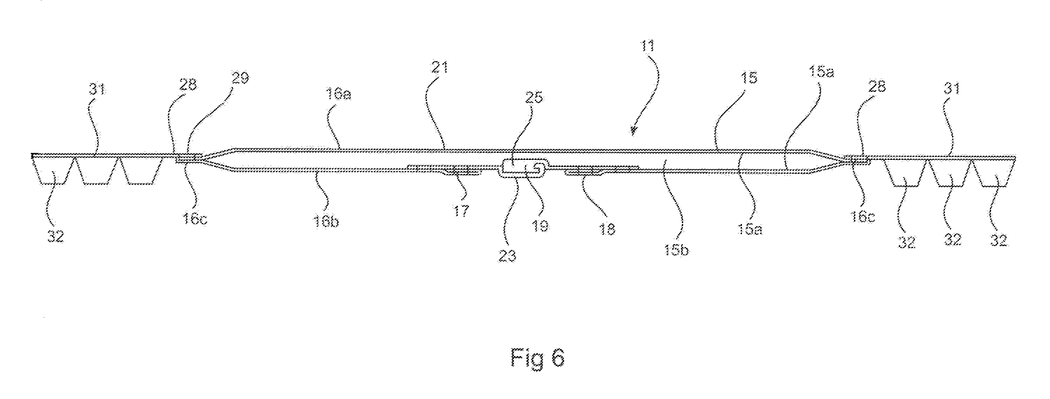

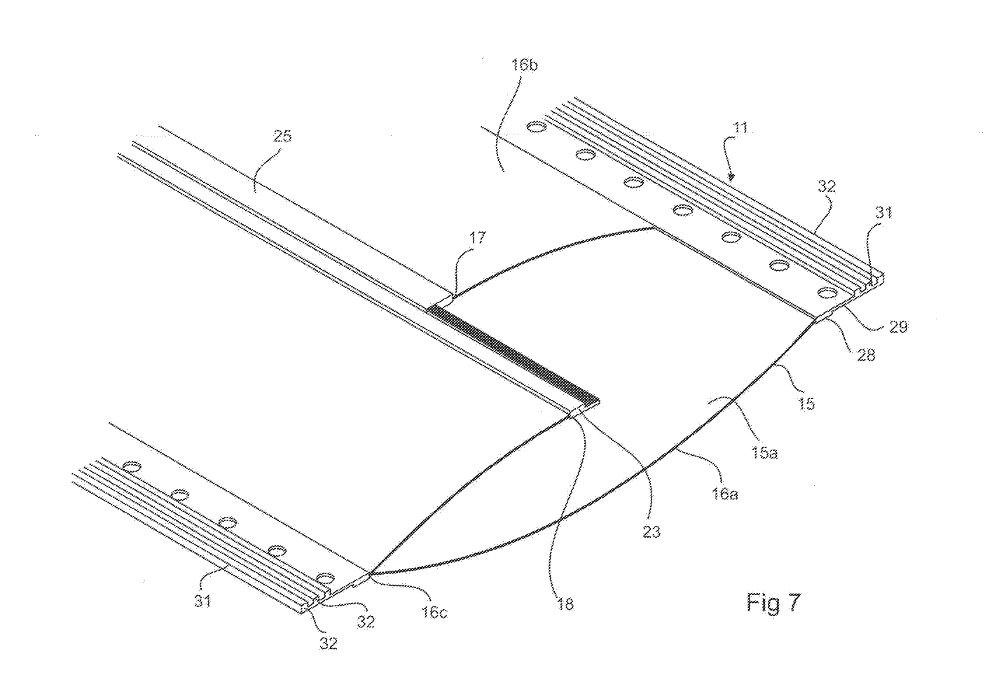

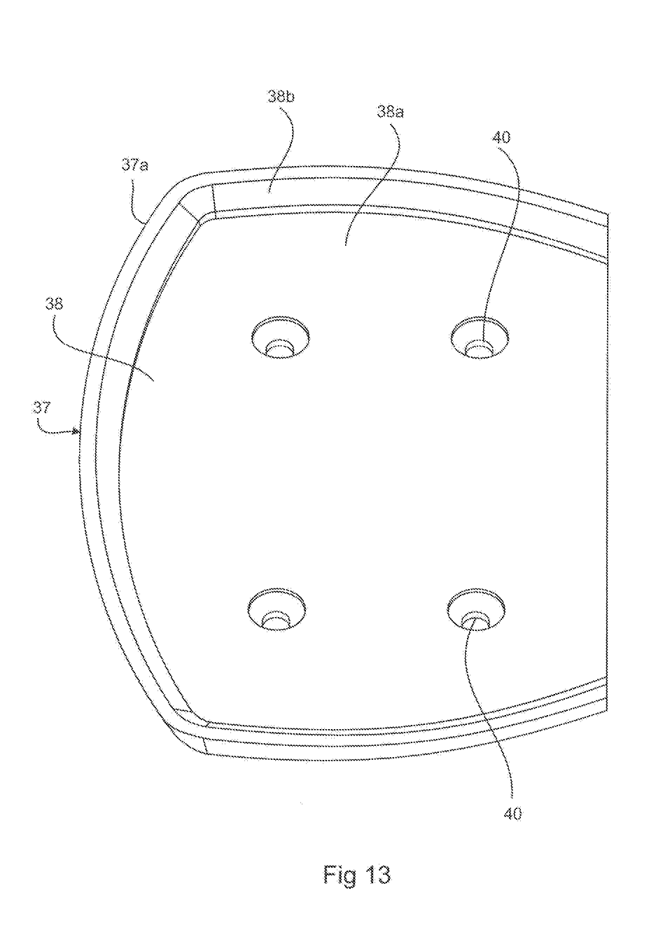

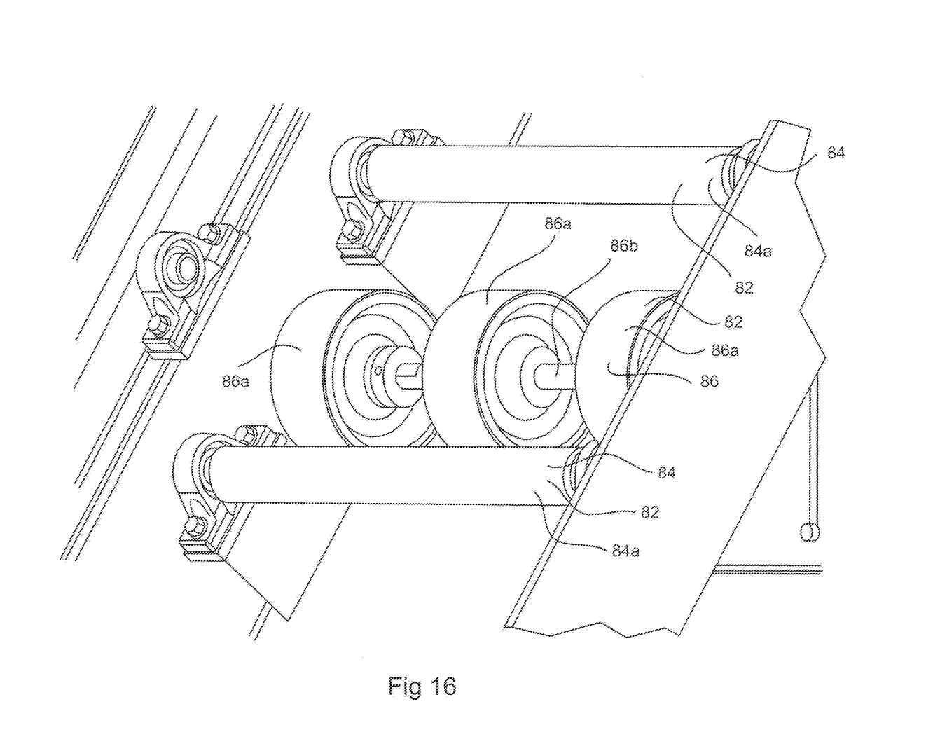

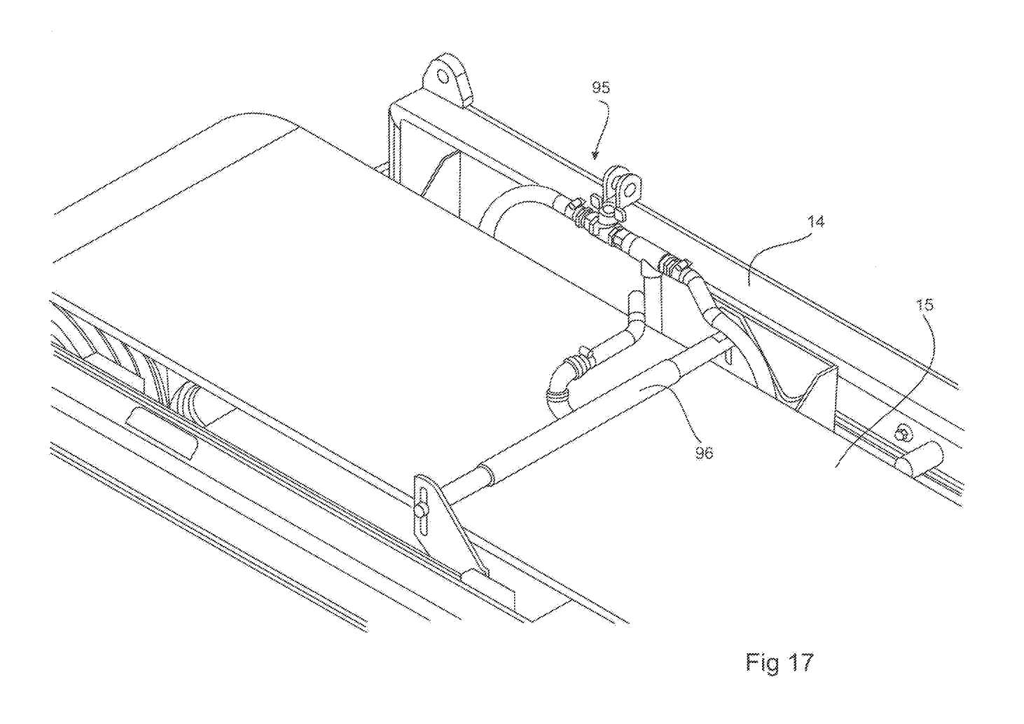

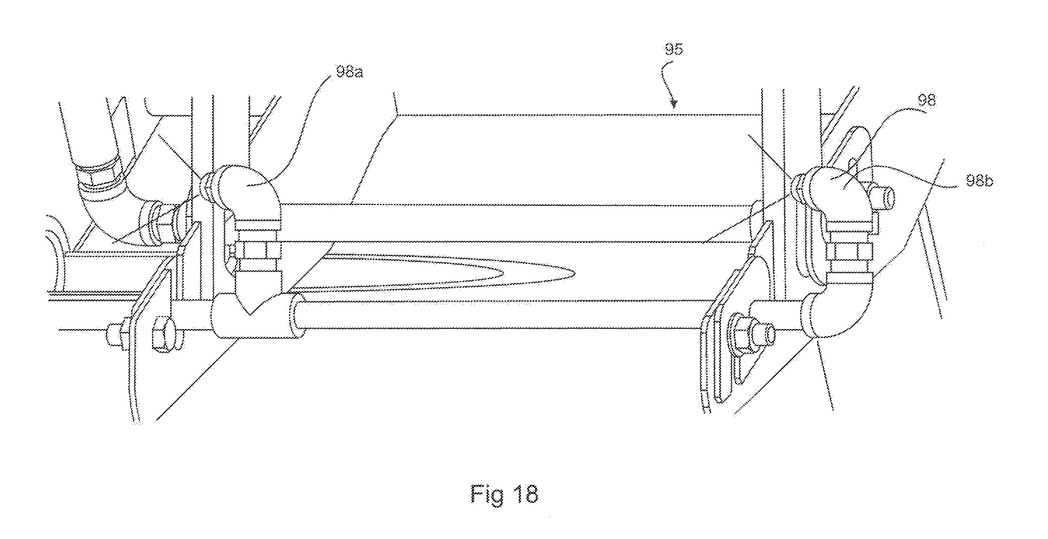

The first embodiment, which is shown in FIGS. 1 to 20 of the drawings, is directed to a belt filter apparatus 10 for treating material to separate solid and liquid components thereof. The apparatus 10 according to this embodiment has been devised particularly for treating sludge material such as sewage for the purposes of dewatering the sludge material to facilitate recovery of the solid matter for subsequent treatment. There may, of course, be various other applications for the belt filter apparatus 10.

The apparatus 10 comprises an endless belt structure 11 adapted to circulate around a path 12 incorporating guide roller structures 13 around which the belt structure passes. The endless belt structure 11, the guide roller structures 13 and other componentry are supported within a mobile frame structure 14.

In this embodiment, the belt filter apparatus 10 is of a configuration and size to facilitate transportation to and from a site of intended use, and to be manoeuvred around the site. In particular, the belt filter apparatus 10 is of a configuration and size to permit it to be moved through a standard doorway. Specifically, this embodiment of the belt filter apparatus 10 is about 2.1 meters high, 700 mm wide and of a weight less than one tonne. These size and weight specifications are provided for illustrative purposes only. The belt filter apparatus 10 is, of course, not limited to these size and weight specifications.

The endless belt structure 11 comprises an elongate belt portion 15 formed of sheet material; specifically, fluid permeable sheet material, such as for example a flexible filter pad material such as woven polypropylene. In this embodiment, which involves dewatering sludge material, the elongate belt portion 15 is formed of water permeable sheet material.

The belt portion 15 comprises two opposed longitudinal edges 17, 18. The belt portion 15 further comprises two interconnected longitudinal sections 16a, 16b, with longitudinal section 16b being split to provide the two longitudinal edges 17, 18. The bet portion 15 has an inner surface 15a defined by the confronting longitudinal sections 16a, 16b.

The two longitudinal sections 16a, 16b may be formed of the same material or different materials, although in this embodiment at least one of the two longitudinal sections is made of the aforementioned fluid permeable sheet material (such as for example a flexible filter pad material such as woven polypropylene). While it is preferable that both two longitudinal sections 16a, 16b be fluid permeable, it is not necessarily essential and only one need be fluid permeable. As a result of being spilt to provide the two longitudinal edges 17, 18, the longitudinal section 16b comprises two portions, each defining one of the longitudinal edges 17, 18.

The endless belt structure 11 further comprises a connection means 19 for releasably connecting the two longitudinal edges 17, 18 of the belt portion 15 together so as to form a tubular structure 21 having a flexible side wall 22. The elongate cavity 15b :enclosed by the tubular structure 21 is bounded by the inner surface 15a of the belt portion 15. The cavity 15b constitutes a compartment within the assembled tubular structure.

The material from which longitudinal section 16b of the belt portion 15 is made is preferably sufficiently flexible to allow the two portions which define the longitudinal section 16b to be folded between closed and open conditions corresponding to assembled and disassembled conditions of the tubular structure 21.

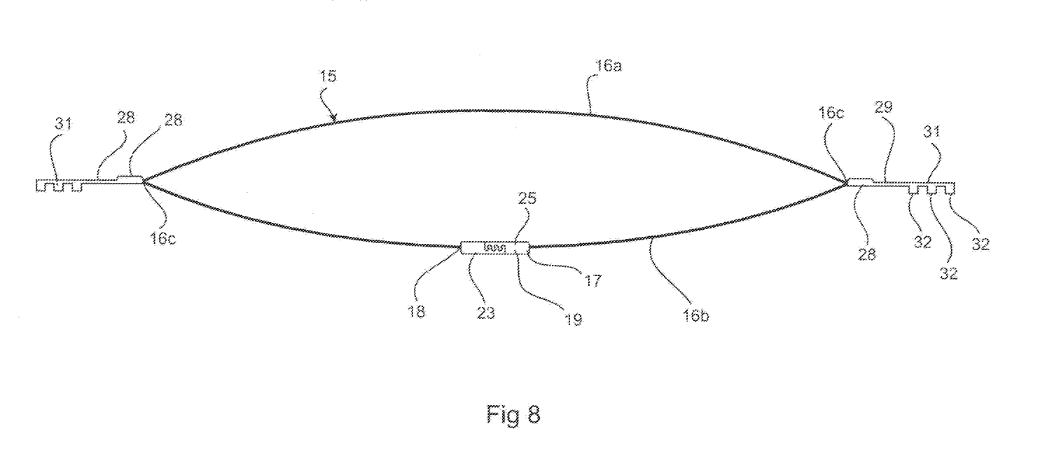

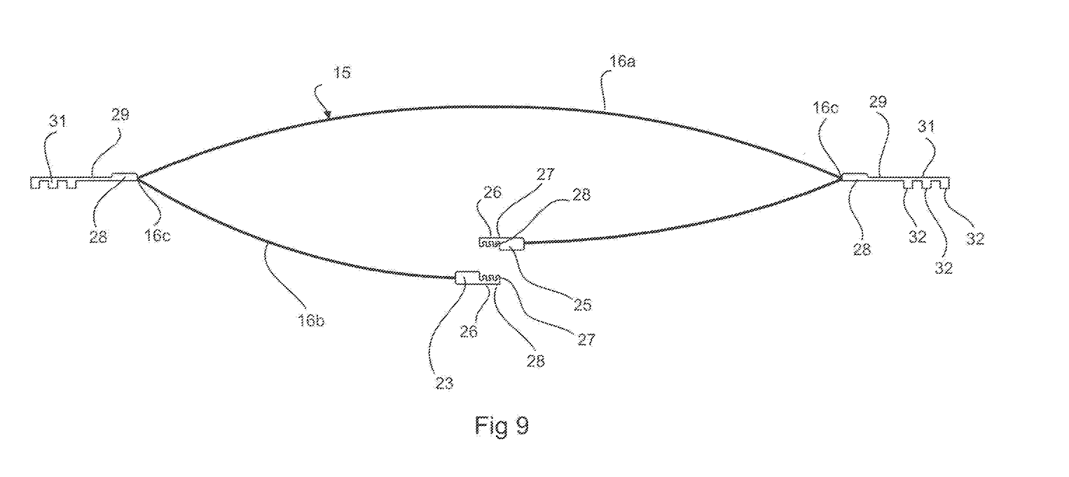

The connection means 19 comprises a slider connector means in the form of a zipper. A particularly suitable slider connector means is the type disclosed in U.S. Pat. No. 6,467,136 in the name of Neil Deryck Bray Graham, the contents of which are incorporated herein by way of reference. In the arrangement shown, the slider connector means 19 comprises two connector elements 23, 25 which are identical in construction, each presenting a contact face 26 and spaced apart longitudinal ribs integral with and projecting from the contact face to define a series of ridges 27 and recesses. The ridges 27 and recesses 28 on the two connector elements 23, 25 are arranged to interact with each other in order to releasable connect the two connector elements together. The two connector elements 23, 25 are shown in an interconnected condition in FIG. 8 and in a separated condition in FIG. 9. In the interconnected condition, the ridges 27 on one connector element engage with the recess 28 on the other connector element, and vice versa, as shown in FIG. 8.

The endless belt structure 11 further comprises two endless funicular elements 31 connected to the belt portion 15 by connecting portions 28. The funicular elements 31 are adapted to support the belt portion 15 therebetween. Further, the funicular elements 31 not only support the belt portion 15 therebetween but also guide and drive the endless belt structure 11 around the path 12. The connecting portions 28 allow the assembled tubular structure 21 to pass around the guide roller structures 13 without damage. Further, the connecting portions 28 serve to transfer loading between the funicular elements 31 and the belt portion 15. The loading typically comprises loads arising from the driving and/or guiding functions performed by the funicular elements 31.

In the arrangement shown, each connecting portion 28 comprises a flexible connection strip 29 extending laterally between the belt portion 15 and the respective funicular element 31 and also extending longitudinally with respect thereto. The connection strip 29 is connected to the heft portion 15 at the adjacent junction 16c between the longitudinal sections 16a, 16b thereof. Each connecting portion 28 may, of course, take any other appropriate form. By way of example, in one other arrangement each connecting portion 28 may comprise a plurality of connecting elements spaced at intervals along the marginal area between the belt portion 15 and the respective funicular element 31. In yet another arrangement, each connecting portion 28 may be configured as a perforated sheet or belt. In still yet another arrangement, each connecting portion 28 may be configured as net or webbing comprising fibres or fibre bundles disposed angularly (say at 45/45) to the funicular elements 31 and the longitudinal extent of the belt portion 15 to transfer the guide or drive loads between the funicular elements and the belt portion. With such an arrangement, the net or webbing would be open to allow the water that is being expelled from the tubular structure to exit the arrangement and drain therefrom efficiently.

The funicular elements 31 may be of any appropriate form, such as, for example, bolt ropes, cables or drive transmission chains. In the arrangement shown, each funicular element 31 comprise several drive transmission belts 32 positioned in side-by-side relation and connected together to function as a unit. Each funicular element 31 may be formed as an integral structure incorporating integral formations which provide the function of the drive transmission belts 32.

The funicular elements 31 engage the roller structures 13, as will be explained later.

Each roller structure 13 comprises two wheels 14 supported on a shaft 16. Each wheel 14 has an outer periphery 14a configured to guidingly receive a respective one of the funicular elements 31. In the arrangement where the funicular elements 31 comprise ropes or cables, the outer peripheries 14a may be configured as rims having peripheral grooves in which the funicular elements are received. In the arrangement where the funicular elements 31 comprise drive transmission chains, the wheels 14 may comprise sprockets having teeth at outer peripheries 14a for engaging the chains.

In the arrangement shown (in which the funicular elements 31 each comprise several drive transmission belts 32 positioned in side-by-side relation and connected together to function as a unit), each wheel 14 is configured as a pulley wheel having a rim 14b which defines the outer periphery 14a and which includes several grooves 14c for receiving the respective drive transmission belts 32.

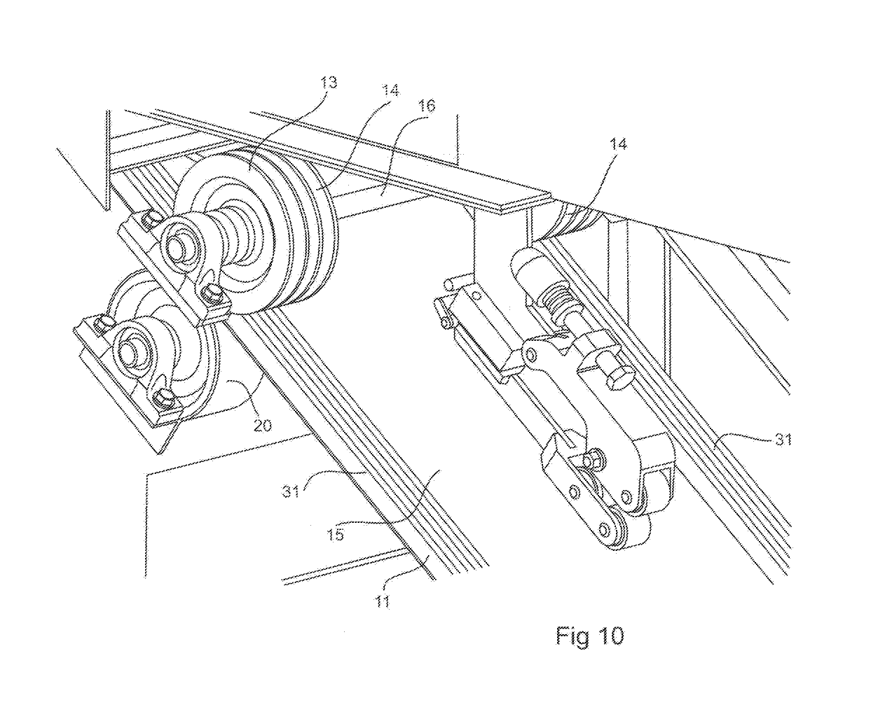

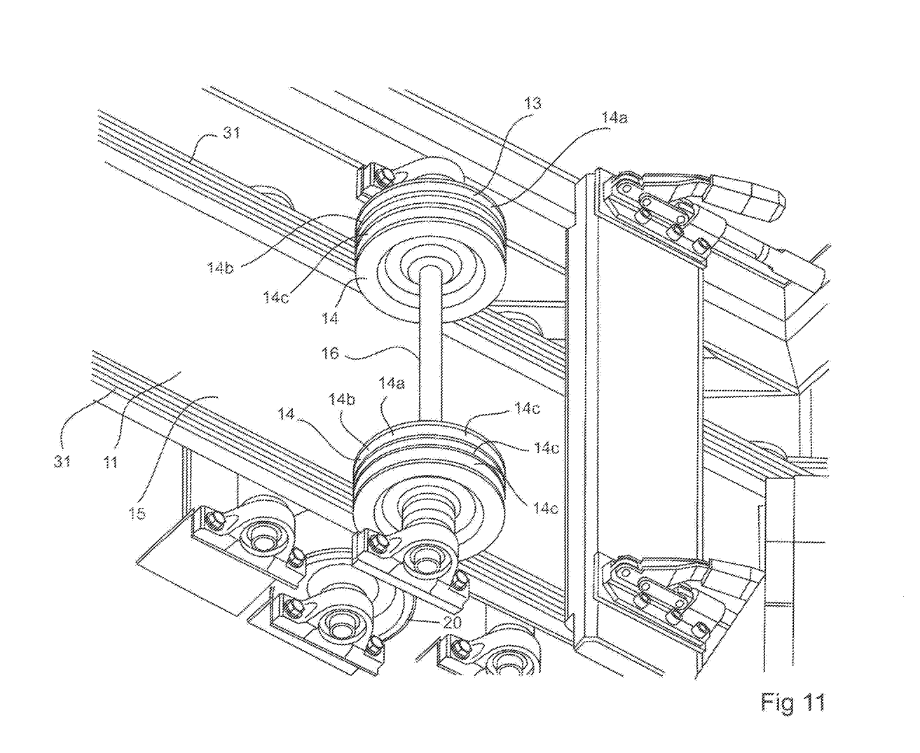

A support 20 is typically provided in opposed relation to each wheel 14 to cooperate with the wheel to assisting in maintaining the respective funicular element in engagement with the wheel. The support acts onto the opposed side of the funicular element to guide and constrain the funicular elements so as to maintain engagement with the wheel. In the arrangement shown, the support comprises a roller, as best seen in FIGS. 10 and 11.

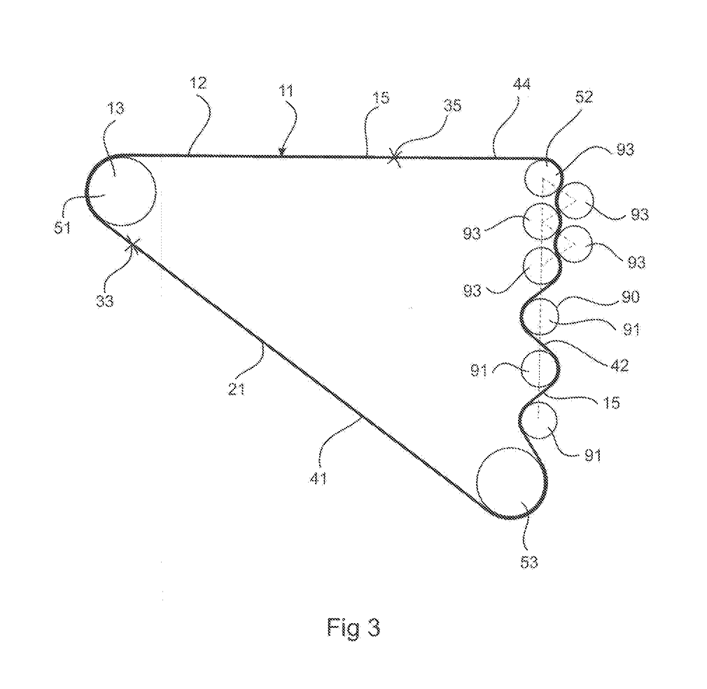

The circulating path 12 includes an assembly zone 33 at which the longitudinal edges 17, 18 of the belt portion 15 are brought together and interconnected by way of the connection means 19 to form the tubular structure 21, and a disassembly zone 35 at which the connection means 19 is released to separate the longitudinal edges 17, 18 and the tubular structure 21 subsequently opened. The locations of the assembly zone 33 and the disassembly zone 35 are identified schematically in FIG. 3.

The assembly zone 33 includes a slider 34 which operates in conjunction with the two connector elements 23, 25 to move them together into zipping engagement as the endless belt 11 circulates around path 12.

The disassembly zone 35 includes a splitter 36 operable to progressively pull the two connector elements 23, 25 apart in an unzipping action as the endless belt 11 circulates around path 12.

With this arrangement, the In edges 17, 18 of the belt portion 15 are continuously connected together at the assembly station 33, and the interconnected longitudinal edges 17, 18 are continuously separated at the disassembly zone 35 so as to split the tubular structure 21 as the endless belt 11 circulates around the path 12.

The assembly zone 33 comprises supplementary guide rollers (not shown) to progressively move the belt portion 15 from an open generally flat condition, through an arcuate condition, and to ultimately assume a closed condition at which the longitudinal edges 17, 18 are connected together by way of the connection means 19 (under the action of the first slider 34) to form the tubular structure 21. The supplementary guide rollers may comprise “V” rollers (not shown) for tensioning the belt portion 15 to maintain a generally uniform tension on the belt portion 15 as it is zipped closed.

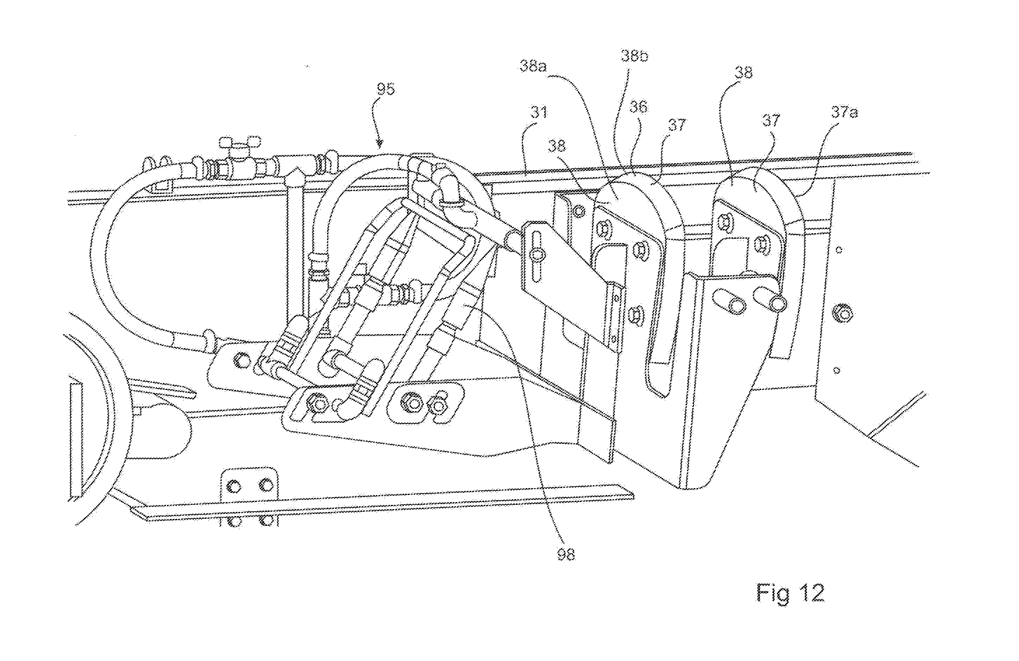

At the disassembly zone 35, the splitter 36 acts to progressively unfurl the belt portion 15 from the closed condition forming the tubular structure 21 to the condition in which it is open. In the arrangement shown, in FIG. 12, the splitter 36 comprises scrapers 37 each presenting an edge 37a over which the inner surface 15a of the belt portion 15 passes, with the edge 37a being configured to cause the interconnected longitudinal edges 18, 19 of the approaching tubular structure 21 to separate. In other words, the scraper 37 functions as a guide arrangement for progressively moving the belt portion 15 from the dosed condition forming the tubular structure 21 to the condition n which it is open such that the inner surface 15a of the heft portion 15 is exposed. The scraper edge 37a also serves to scrape remnant dewatered sludge material from the inner side 15a of the belt portion 15. The scraper 37 presents a surface at edge 37a for sliding contact with the inner surface 15a of the belt portion 15 whereby the belt portion 15 is maintained in a taut condition as is unfurls from the dosed condition to the open condition, thereby avoiding folds or wrinkles in the unfurling belt portion 15. While not shown in FIG. 12, there is also provided lifting means for lifting the path of each funicular dement 31 such that the funicular elements 31 each assume the elevated disposition. Such lifting means may comprise a roller over which the respective funicular element 31 travels to be pushed-up thereby into the elevated disposition.

With this arrangement, the scraper 37 is pressed into the belt portion 15 as it unfurls from the dosed condition forming the tubular structure 21 to the of in which it is open. This combined with the lifting of the funicular elements 31 causes a corner to be formed by the point of the scraper 37 and thus the outside of the corner has a greater distance to travel than the inside. In this way the relative distance of the inside track is less than the outside track, reducing the tension/stress on the slider connector means 19. This reduction in the tension/stress on the slider connector means 19 of the approaching tubular structure 21 assists in the separation of connector elements 23, 25 and allowing the material to be easily drawn down the side of the scraper for effective cleaning.

The scrapers 37 are pressed into the belt portion 15 as the latter unfurls from the dosed condition forming the tubular structure 21 to the open condition, with edge 37a in sliding contact with the inner surface 15a of the belt portion 15 so that the belt portion 15 is maintained in a taut condition as is unfurls from the dosed condition to the open condition.

The scraper 37 comprises a body 38 having a central portion 38a and a peripheral edge portion 38b, which defines the edge 37a, for contacting the belt portion 15 as it unfurls from the closed condition to the open condition. The peripheral edge portion 38b projects from the central portion 38a towards the approaching tubular structure 21. With this arrangement, the peripheral edge portion 38b presents the leading edge 37a to the oncoming belt portion 15 to scrape remnant sludge material from the inner surface 15a. Because of the configuration of the peripheral edge portion 38b, remnant sludge material scrapped from the inner surface 15a of the oncoming belt portion 15 is directed inwardly towards the central portion 38a rather than accumulating at the edge 38b. The body 38 incorporates mounting holes 40 for mounting the scraper 37 in position.

The path 12 around which the endless beg structure 11 circulates comprises a downwardly inclined working run 41, an upwardly extending working run 42, and a generally horizontal discharge and return run 44. The assembled tubular structure 21 extends from the assembly zone 33, along the downwardly inclined working run 41, along the upwardly extending working run 42, and part way along the horizontal discharge and return run 44 to the disassembly zone, as shown in FIG. 3.

The roller structures 13 incorporated in the path 12 comprises first and second upper turn rollers 51, 52, and a lower turn roller 53. The roller structures 13 also include intervening support rollers.

In the arrangement shown, the downwardly inclined working run 41 extends between first upper turn roller 51 and the lower turn roller 52. Further, the upwardly extending working run 42 extends between the lower turn roger 52 and the second upper turn roller 52. Still further, the generally horizontal discharge and return run 44 extends between the second upper turn roller 52 and the first upper turn roller 51.

At least one of the roller structures 13 is adapted to be driven to move the endless belt structure 11 around the path 12.

The belt portion 15 has a closed condition in which the longitudinal edges 17, 18 are interconnected to form the tubular structure 21. Otherwise, the belt portion 15 is in an open condition in which the inner surface 15a is exposed. In the arrangement shown, the belt portion 15 occupies the dosed condition in which the longitudinal edges 17, 18 are interconnected to form the tubular structure 21 in travelling from the assembly zone 33 to the disassembly zone 35. Further, the belt portion 15 occupies the open condition in which the longitudinal edges 17, 18 are separated in travelling from the disassembly zone 35 to the assembly zone 33.

The belt portion 15 is in an open condition when the belt structure 11 passes around first upper turn roller 51; at that stage, assembly of the tubular structure 21 has not yet commenced. The belt portion 15 undergoes assembly into the configuration of the tubular structure 21 as it advances through the assembly zone 33. The assembly is completed once the two longitudinal edges 17, 18 are interconnected by being zippered together by the slider 34; at that stage the belt portion 15 is dosed and forms the tubular structure 21. The slider 34 is adapted to hold, align, support, dean, lubricate, and press the connector element 23 provided along longitudinal edge 17 and the complimentary connector dement 25 provided along longitudinal edge 18 together so as to reliably connect one longitudinal edge to the other. As the belt portion 15 progressively moves from the open condition to the closed condition, it forms an open channel portion which progressively closes upon itself unto the tubular structure 21 is formed.

A delivery means 70 is provided for introducing sludge material into the tubular structure 21. The delivery means 70 includes a delivery pipe 71 extending into the almost assembled tubular structure 21 through the open upper end thereof between the two longitudinal edges 17, 18 immediately before the latter are interconnected by being zippered together to complete assembly of the tubular structure. The delivery pipe 71 is configured to present a narrow profile to the oncoming belt structure as it approaches the assembly zone 33. Typically, the delivery pipe 71 is elongate in cross-section, with the major axis extending in the direction of travel of the oncoming belt structure and the minor axis disposed transversely to the direction of travel thereby presenting the narrow profile to the oncoming belt structure. The delivery pipe 71 communicates with a distribution head (not shown) which is configured to distribute the sludge material within the assembled tubular structure 21 across the width thereof.

In the downwardly inclined working run 41, liquid within the sludge material can drain from the tubular structure 21 through the permeable side wall thereof under the influences of gravity, as will be explained in more detail later. Similarly, liquid can be expressed from the tubular structure 21 through the permeable side walls thereof in the upward working run 42 under the influences of compressive and compaction forces exerted on the corresponding portion of the tubular structure 21, as will also be explained in more detail later.

A collection structure 60 is positioned below the working runs 41, 42 for collection of liquid discharging therefrom. The collection structure 80 incorporates a discharge path (not shown) from which the collected liquid can be removed and delivered to another location for further processing or handling as required.

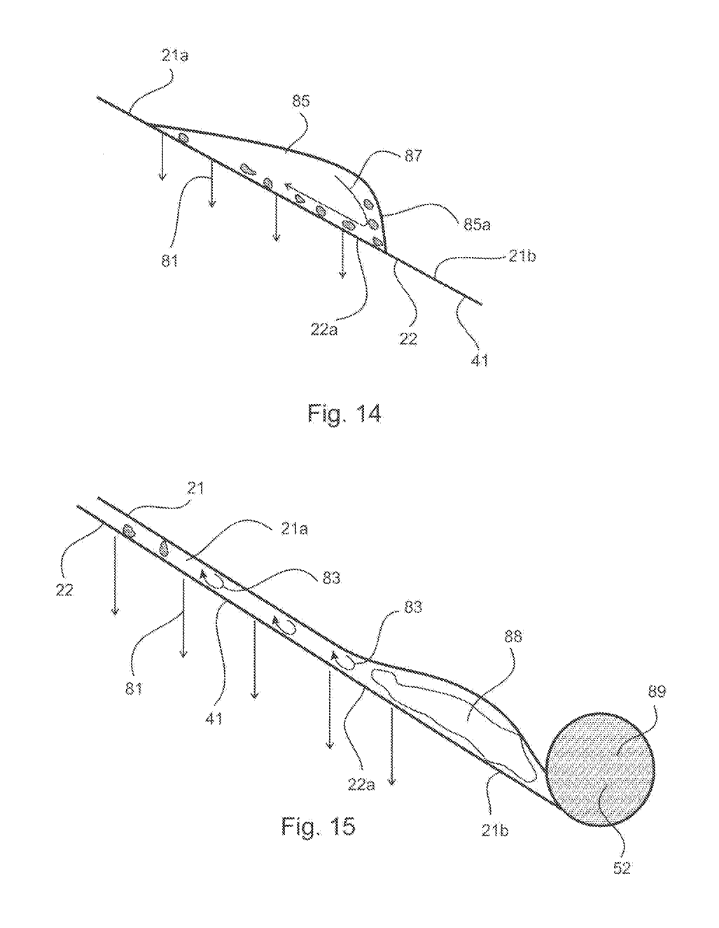

The downwardly inclined working run 41 comprises a descending portion along which the assembled tubular structure 21 passes. Liquid draining from the liquid within the sludge material can drain from the tubular structure 21 through the permeable side wall thereof under the influences of gravity, as depicted schematically in FIGS. 14 and 15 by arrows 81.

There is, however, a tendency for solid particulates in the sludge material to migrate onto the side wall 22 of the tubular structure 21, particularly onto the lower surface section 22a thereof, and accumulate into a cake which eventually blinds the tubular structure, leading to a loss of or reduction in its permeability. The lower surface section 22a effectively constitutes a bed over which the sludge material flows.

This is addressed in the present embodiment by appropriate selection of the inclination of the working run 41 along which the descending portion 21a of the tubular structure 21 travels whereby at least some of the particulate solids in the sludge material are caused to move downwardly within and relative to the tubular structure 21 along the descending portion 21a under the influence of gravity to facilitate cleaning of the permeable tubular structure. The cleaning of the interior surface of the tubular structure comprises removal of accumulated solid matter, particularly matter accumulating on the lower surface section 22a, which would otherwise cause blinding of the permeable tubular structure 21 and prevent or inhibit drainage of liquid therefrom.

With this arrangement, particulate solids are mobilized in the descending portion 21a of the permeable tubular structure 21, serving to scour the lower surface section 22a to erode or otherwise remove accumulated material which might otherwise lead to blinding of the tubular structure and a resultant loss of or reduction in its permeability.

The scouring action developed by the mobilized particulate solids comprises removal of accumulated material by frictional effects on the accumulated material and/or hydrodynamic forces developed in the liquid within the tubular structure through movement of the particulate solids. This is illustrated in FIG. 15 of the drawings in which arrows 83 depict the path of particulate solids rolling and tumbling down the descending portion 21a of the tubular structure 21, causing the scouring action.

As a result of the rolling and tumbling action down the descending portion 21a of the permeable tubular structure 21, the interstitial spaces between the particulate solids expand and contract, facilitating the release liquid trapped in those spaces.

The delivery of sludge material into the tubular structure at the delivery means 70 is controlled such that the tubular structure 21 does not completely fill. Rather, the delivery is controlled to allow the sludge material to flow downwardly along at least an upper section of the inclined descending portion 21 a thereby encouraging particulate solids within the sludge material to move downwardly along the descending portion in a tumbling and rolling action under the influence of gravity, as mentioned previously, to facilitate cleaning, of the permeable tubular structure 21.

The descending portion of the path 12 along which the assembled tubular structure 21 passes is configured to provide support for the inclined descending portion 21a of the tubular structure 21 advancing therealong. The support is configured to cause disturbance of material flow within the tubular structure and to also spreading of the material within the tubular structure. More particularly, the support is configured to create turbulence in the downwards flow and spread the flow to optimise the area within the tubular structure being utilised to allow the scouring process to occur and also optimise the area over which liquid can leave the tubular structure.

The support is provided by at least support portion over which the descending portion of the tubular structure travels, and preferably a series of support portions located at intervals along the descending portion of the path. The support portions may be of any appropriate form, including discrete elements such as rollers or bars, and a structure which incorporates integral support portions such as for example a washboard structure. Typically, the support elements would establish locally raised sections within the bottom of the descending portion of the tubular structure 21 to thereby define an uneven bed over which material within the descending portion of the tubular structure flows.

In the arrangement shown, the support is provided by a series of support elements 82 located at intervals along the descending portion of the path. The support elements 82 comprise cylindrical rollers 84 and roller assemblies 86 disposed in alternating relation along the descending portion of the path. The cylindrical rollers 84 each present a rolling surface 84a for supporting the underside of the tubular structure 21 continuously across the width thereof. The roller assemblies 86 comprise rollers 86a rotatably supported in spaced apart relation on a common axle 86b. In the arrangement shown there are three rollers 86a, being two end rollers and an intermediate roller. The intermediate roller may be of a larger diameter than the end roller, although this is not necessarily so. The end rollers 86a may also function as rollers providing support 20 as previously described on the opposed side of the respective funicular elements 31 to guide and constrain the funicular elements so as to maintain engagement with the respective wheels 14.

The combination of support elements 82 located at intervals along the descending portion of the path causes the underside of the descending portion of the tubular structure 21 to be deformed in a manner which induces deformations to in the tubular structure, thereby established the uneven bed over which material within the descending portion of the tubular structure flows. The uneven bed serves to create turbulence in the downwards flow and spread the flow to optimise the area within the tubular structure being utilised to allow the scouring process to occur and also optimise the area over which liquid can leave the tubular structure.

The flow of sludge material along the inclined descending portion 21a of the tubular structure 21 slows towards the bottom section thereof, leading to an accumulation of solids. The slowing occurs because of increased friction arising from the loss of liquid, the friction being between particulate solids and also between the particulate solids and the surface of the tubular structure. As the liquid is released from between the particulate solids and escapes from the tubular structure 21, the friction between the particles increases and the flow slows, causing the particulate solids to commence to agglomerate. This leads to caking and also thickening of the caked mass, with the progressively developing caked mass rolling or tumbling down the inclined descending portion 21a of the tubular structure 21, as depicted in FIG. 14 in which the agglomerated mass is depicted in outline and identified by reference numeral 85.

The agglomerated mass 85 advances down the inclined descending portion 21a of the tubular structure 21, with the front face 85a thereof progressively everting in the downward advance, as depicted by arrow 87 in FIG. 14. As shown, the eversion is such that the front face 85a turns downwardly and rearwardly with respect to the direction of advance. This action slows the flow and also assists in dewatering the agglomerated mass 85. In particular, the front face 85a is continually pulled under the advancing agglomerated mass 85 by virtue of friction between the particulate solids and the side wall 22 of the tubular structure 21.

Further, the leading section of the agglomerated mass 85 acts as a dam for following particulate solids, regarding their flow and allowing further release of liquid.

The agglomerated mass 85 accumulates at the bottom of the inclined descending portion 21a of the tubular structure 21 as a thickened solids cake as depicted in FIG. 15 (in which the thickened solids cake is depicted in outline and identified by reference numeral 88). The agglomerated mass $5 accumulates in such a manner because it cannot escape from within the enclosed tubular structure 21.

The accumulating thickened acids cake 88 is transported around turn section 89 defined by the lower turn roller 53. The turn section 89 is configured to progressively convey the thickened solids cake 88 within the tubular structure 21 to the upwardly extending working run 42 without subjecting it to compaction. This is facilitated by the tubular structure being an enclosed arrangement from which the thickened solids cake 88 cannot escape.

In particular, the turn section 89 is configured to propagate radial expansion and contraction of successive sections of the tubular structure 21 as it advances about the turn section, thereby to convey the thickened solids cake 88 within the tubular structure around the turn section.

In this embodiment, the lower turn roller 53 comprises a roller having an outer periphery about which the tubular structure passes, the outer periphery being defined by a plurality of circumferentially spaced elements (not shown) with cavities (also not shown) therebetween. Such a roller will hereinafter be referred to as a “squirrel cage roller” for ease of reference. With this arrangement, the circumferentially spaced elements cause contraction of success vie sections of the tubular structure 21 as it advances about the turn section 89 and the intervening cavities accommodate corresponding radial expansion of successive sections of the tubular structure. The radial expansion of successive sections of the tubular structure 21 establishes a series of pockets within the tubular structure about the turn section 89. This action is somewhat akin to a peristaltic action in that there is radial contraction and radial expansion of successive sections of the tubular structure 21, although the thickened solids cake within the tubular structure is not pumped along the tubular structure. Rather, the thickened solids cake continues to advance with the tubular structure 21 and move upwards with the tubular structure 21 (instead of falling down the tubular structure after having passed through the turn section 89), the radial expansion merely accommodating material displaced as a result of the radial contraction arising from engagement with the lower turn roller 53. In particular, the thickened solids cake is trapped in the pockets established in the tubular structure by the circumferentially spaced elements of the squirrel cage roller and thus is forced to continue to advance with the tubular structure 21.

The upwardly inclined working run 42 includes a pressing station 90 at which the tubular structure 21 is subjected to compaction to extract further liquid from the sludge material contained the-rein and then compression to assist in drying the remnant solids material. The liquid so extracted discharges from the tubular structure 21 through the permeable Side wails thereof and drains into the collection structure 80.

With this arrangement, the turn section 89 is at the bottom of the descending portion of the path 12, and the pressing station 90 is along a portion of the path 12 after the turn section.

The pressing station 90 comprises a press configured as a series of compaction rollers 91 about which the upwardly inclined working run 42 successively passes in a serpentine path section to effect compaction of the solids cake 88.

The press further comprises a series of compression rollers 93 disposed on opposed sides of the tubular structure to apply a pressing action to the portion of the tubular structure 21 passing therebetween to squeeze the tubular structure 21 and thus extract further liquid from the solids cake 88.

In this embodiment, the uppermost compression roller 93 also constitutes the second upper turn roller 52.

As part of the process of lifting the tubular structure 21 upwards and away from the turn section 89, water continues to be displaced from within the tubular structure. Some of the displaced water can adhere to the exterior of the tubular structure 21 and be carried therewith. It is advantageous that this adhering water is removed as quickly as possible to enhance the escape of the water from the tubular structure. Accordingly, a scraper/wiper system is provided to engage the exterior of the tubular structure 21 to cause liquid adhering thereto to be released. The scraper/wiper system may comprise one or more scrapers or wipers. The scrapers or wipers may comprise plastic scraper blades. In this way, the adhering water is removed as quickly as possible thus enhancing the release of water from the tubular structure 21 between and on the compaction rollers 91. In this way the tubular structure 21 is dried further prior to being presented to compression roller 93.

The discharge, run 44 includes the disassembly zone 35 at which the connection means 19 is released to separate the longitudinal edges 17, 18 of the tubular structure 21 and at which the tubular structure 21 is subsequentially opened. The interconnected longitudinal edges 17, 18 are continuously separated at the disassembly zone 35 so as to split the tubular structure 21 as the endless belt 11 circulates around the path 12 and expose the inner surface 15a of the belt portion 15.

At this stage, longitudinal sections 16b of the belt portion 15, which incorporates the two longitudinal edges 17, 18, is on the underside. As the belt portion 15 opens, dewatered sludge material fails from the circulating belt structure 11. The scraper 37 acts to scrape any remnant dewatered sludge material from the inner side 15a of the belt portion 15.

A collection zone 94 is provided for receiving dewatered sludge material falling from the belt portion 15 as it opens from the tubular structure 21. The collection zone 94 may be configured to receive and transfer the collected sludge material to another location for subsequent processing.

The discharge run 44 also includes a washing station 95 as best seen in FIG. 12. The washing station 95 comprises a spray system 96 above the pelt portion 15 for spraying a washing fluid such as water onto the belt portion 15 from the outer side thereof. The spray system 96 comprises an overhead spray bar arranged to spray washing fluid onto and into the belt portion 15. The spray can penetrate the permeable side ways of the belt portion 15, so cleaning the inner surface 15a thereof. Additionally, or alternatively, the washing station 95 may comprise means for generating a fine curtain of washing fluid such as water arranged to be directed through the filter material of the belt portion 15 to dislodge trapped remnant material. By way of example, such means may comprise a tube provided with a longitudinally extending slot through which water can issue under pressure to provide the fine curtain of water, the tube being pressed into direct contact with the belt portion 15 so that the water exiting the slot in the tube is driven through the filter material dislodging any trapped materials in the filter.

The washing station 95 further comprises a further spray system 98 for cleaning the connector elements 23, 25 prior to them being brought together into zipping engagement as the endless belt 11 circulates around path 12. In the arrangement shown, the further spray system 98 comprises two sprays 98a, 98b for spraying a cleaning fluid such as water onto the connector elements 23, 25 to wash any accumulated remnant material from the connector elements 23, 25 prior to them being brought together into zipping engagement.

After passing along the discharge run 44, the belt structure 11, with the belt portion 15 now in an open condition, turns about the first upper turn roller 51 and commences the downwardly inclined working run 41 which comprises the descending portion along which the assembled tubular structure 21 passes.

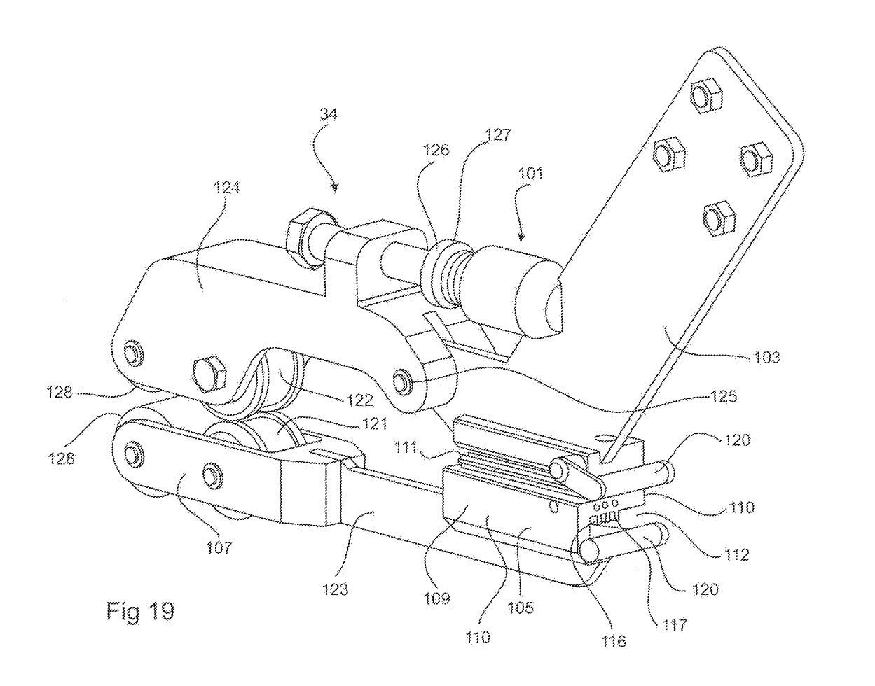

As mentioned above, the assembly zone 33 includes slider 34 which operates in conjunction with the two connector elements 23, 25 to move them together into zipping engagement as the endless belt 11 circulates around path 12. As shown in FIGS. 19 and 20, the slider 34 comprises a slider assembly 101 comprising a support bracket 103 carrying an alignment mechanism 105, and a closure mechanism 107.

The alignment mechanism 105 comprises a body 109 having opposed faces 110 and two passages 111, 112, each configured to receive one of the connector elements 23, 25. The two passages 111, 112 are disposed on opposed sides of the body 109, one above the other in order to align the connector elements 23, 25 in preparation for being brought together into the interconnected condition. Each passage 111, 112 has an outer longitudinal side 113 which opens onto the respective side of the body 109 and a closed inner longitudinal side 115. With this arrangement, the body 109 is disposed between the two connector elements 23, 25, with one connector element passing along passage 111 and me other passing along passage 112. The tree longitudinal edge of each connector element 23, 25 is innermost in the respective passage so as to locate adjacent the closed inner longitudinal side 115. Each connector element 23, 25 extends sidewardly out of its respective passage 111, 112 through the respective outer longitudinal side 113 to the respective longitudinal edges of the belt portion 15.

Each passage 111, 112 is of a cross-sectional configuration which is a counterpart to the cross-sectional profile of the respective the connector element 23, 25. Specifically, each passage 111, 112 includes longitudinal ribs which are in spaced relation and which cooperate to define recesses 116 and ridges 117 which mate with the respective ridges 27 and recesses 28 on the respective the connector element 23, 25. In this way, the connector elements 23, 25 are captively guided along the passages 111, 112 and maintained in alignment in readiness to be later brought together into the interconnected condition, as will be explained in more detail shortly.

The body 109 also has provision for lubricating the connector elements 23, 25 before they are brought together into the interconnected condition. The lubricant is applied to the contact face 26, ridges 27 and recesses 28 of each connector element 23, 25 as it passes along the respective passage 111, 112. In the arrangement shown, the lubricant is delivered into the passages 111, 112 for application to the connect elements 23, 25 via lubricant galleries 118 within the body 109. Lubricant may be delivered into the lubricant galleries 118 in any suitable way, such as via a nipple connection (not shown) fitted to port 119 on the body.

The alignment mechanism 105 further comprises a guide element 120 adjacent the entry end of each passage 111, 112 for guiding the respective connector elements 23, 25 into an entry position as it approaches the passage.

The closure mechanism 107 is provided for urging the aligned connector elements 23, 25 into the interconnected condition after they have moved out of the passages 111, 112. Once the connector elements 23, 25 have moved out of the passages 111, 112, they are disposed one above the other, with the contact faces 26 in face-to-face relation and the respective ridges 27 and recesses 28 in alignment for registration with each other. The closure mechanism 107 operates to press the two connector elements 23, 25 into registration with each other to assume the interconnected condition, as will be explained below.

The closure mechanism 107 comprises two press rollers 121, 122 positioned one above the other, the arrangement being that the aligned connector elements 23, 25 are passed between the two press rollers and pressed into registration with each other to assume the interconnected condition.

The two press rollers 121, 122 are yielding biased towards each other. In particular, press roller 121 comprises a fixed roller, and press roller 122 comprises a floating roller in the sense that it is yielding movable with respect to the fixed roller. The fixed roller 121 is fixed in the sense that it is not movable laterally, it is, however, freely rotatable about its rotational axis.

In the arrangement shown, fixed roller 121 is mounted on a fixed arm 123 and floating roller 122 is mounted on a swing arm 124. The fixed arm 123 is fixed with respect to body 109 and the swing arm 123 is mounted for swinging movement about pivot 125 on the support bracket 103. A biasing mechanism 126 biases the swing arm 124 towards fixed arm 123, thereby to biasing floating roller 122 towards the fixed roller 121. The biasing mechanism 126 comprises spring mechanism 127 which is selectively adjustable for varying the compressible force which can be exerted by the cooperating Dress rollers 121, 122 to press the aligned connector elements 23, 25 into registration with each other to assume the interconnected condition.

The closure mechanism 107 further comprises two guide rollers 129 mounted on the arms 123, 124 for guiding the connected assembly comprising the two interconnected connector elements 23, 25 as it moves away from the slider 34.

As the endless belt structure 11 circulates around the endless path 12, cooperation between the funicular elements 31 and the roller structures 13 ensure proper tracking of the circulating endless belt structure. Further, cooperation between the funicular elements 31 and the roller structures 13 retains the funicular elements 31 away from each other at stages where the tubular structure 21 is undergoing compression. This is to ensure that the compressed tubular structure 21 assumes a taut condition without folds, creases or wrinkles. The presence of folds, creases or wrinkles can be problematic in relation to uniform compression of the material confined within the tubular structure.

As mentioned above, the inclination of the working run 41 along which the descending portion 21a of the tubular structure 21 travels is such at least some of the particulate solids in the sludge material are caused to move downwardly relative to and within the tubular structure 21 along the descending portion 21a under the influence of gravity to facilitate cleaning of the permeable tubular structure.

By way of example, in the arrangement shown the working run 41 along which the descending portion 21a of the tubular structure 21 travels for a sludge material such as sewerage or bio materials has an inclination in the order of 30 to 40 degrees from the horizontal (and more particularly about 30 degrees from the horizontal) and is about 2.3 metres long for a production rate of 420 l/min of paper pulp @ 3% solids with a 5 mm cake thickness and 50-70% solids. The belt portion 15 has a nominal width of about 300 mm between the funicular elements 31.

From the foregoing, it is evident that the first embodiment provides a simple yet highly effective belt filter apparatus 10 for separating solid and liquid components in a material such as sewage undergoing treatment, with provision to inhibit accumulation of particulate solids causing blinding of the permeable belt portion 15. Because of the belt filter apparatus 10 is of a configuration and size to facilitate transportation to and from a site of intended use, and to be manoeuvred around the site, it can be used in the field, such as for example to treat animal sewage undergoing digestion to produce methane.

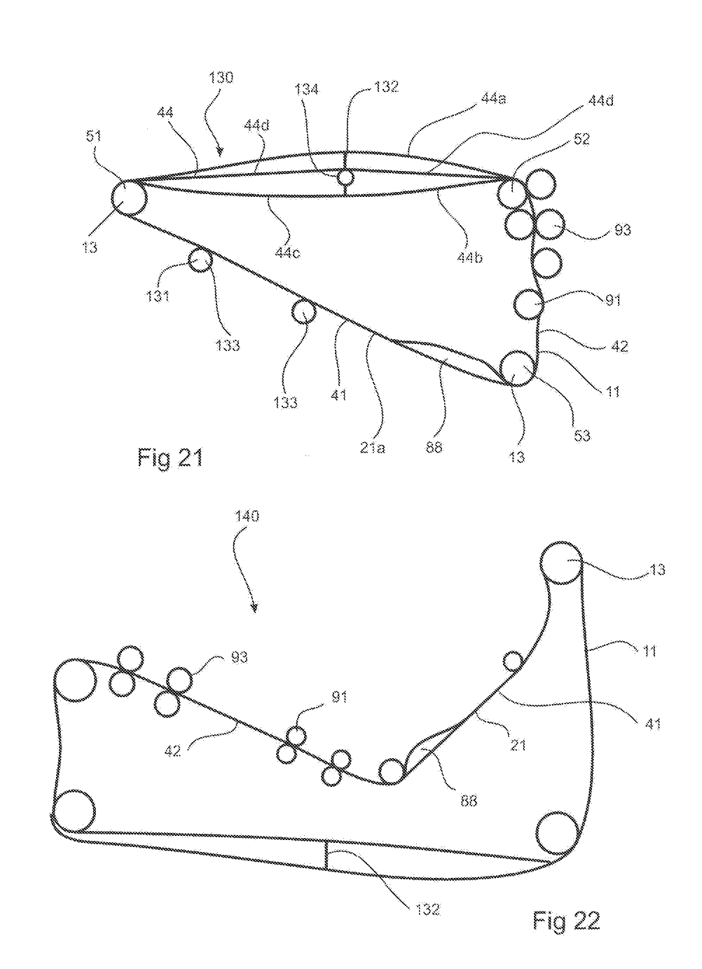

Referring now to FIG. 21, there is shown a belt filter apparatus 130 according to a second embodiment. This embodiment is similar in some respects to the previous embodiment and similar reference numerals are used to denote corresponding pads. In this second embodiment, the configuration of the compaction rollers 91 and the compression rollers 93 at the pressing station 90 is different from the first embodiment. Further, there is shown a support arrangement 131 adapted to provide support for the inclined descending portion 21a of the tubular structure 21 advancing therealong. The support arrangement 131 is configured to cause disturbance of material flow within the tubular structure 21 and to also spreading of the material within the tubular structure. More particularly, the support is configured to create turbulence in the downwards flow and spread the flow to optimise the area within the tubular structure being utilised to allow the scouring process to occur and also optimise the area over which liquid can leave the tubular structure. In the arrangement shown, the support arrangement 131 comprises two support roller structures 133 over which the descending portion 21a of the tubular structure 21 travels at intervals along the descending portion of the path.

One roller structure 133 may comprise an elongate roller extending crosswise of the tubular structure 21 for the purpose of spreading the sludge material across the width of the tubular structure.

The other roller structure 133 may comprise a central miler (not shown) and two side rollers (also not shown) on a common axle in an arrangement similar to that described in the first embodiment.

In the arrangement shown in FIG. 21 the return run 44 is depicted by lines 44a, 44b, 44c and 44d. Lines 44a and 44b represent the path of the belt portion 15 to release the tension on the connector means 19 to facilitate splitting thereof. Line 44c represents the location to which the connector element 23 and the complimentary connector element 25 fail and along which they travel after splitting of the connection means 19. Line 44d represents the paths of the funicular elements 31.

FIG. 21 also depicts a scraper 132 for scraping the inner surface 15a of the belt portion 15 as the tubular structure 21 opens, thereby assisting in removal of the dewatered sludge material. The scraper 132 is similar to counterpart scraper 37 in tile first embodiment.

Further, FIG. 21 depicts a roller 134 for elevating the path 44d of each funicular element 31. There are two rollers 134, one associated with the path 44d of each funicular element 31. This corresponds to the arrangement depicted in FIG. 12, with the rollers 134 providing the lifting means for lifting the path of each funicular element 31 such that the funicular elements 31 assume the respective elevated dispositions referred to previously.

Referring now to FIG. 22, there is shown a belt filter apparatus 140 according to a third embodiment. This embodiment is similar in some respects to the previous embodiment and similar reference numerals are used to denote corresponding parts.

In this third embodiment, the circulating path 12 around which the along which the tubular structure 21 travels is also of a different configuration to that of the first embodiment but nevertheless includes a downwardly inclined working run 41 which comprises the descending portion along which the assembled tubular structure 21 passes.

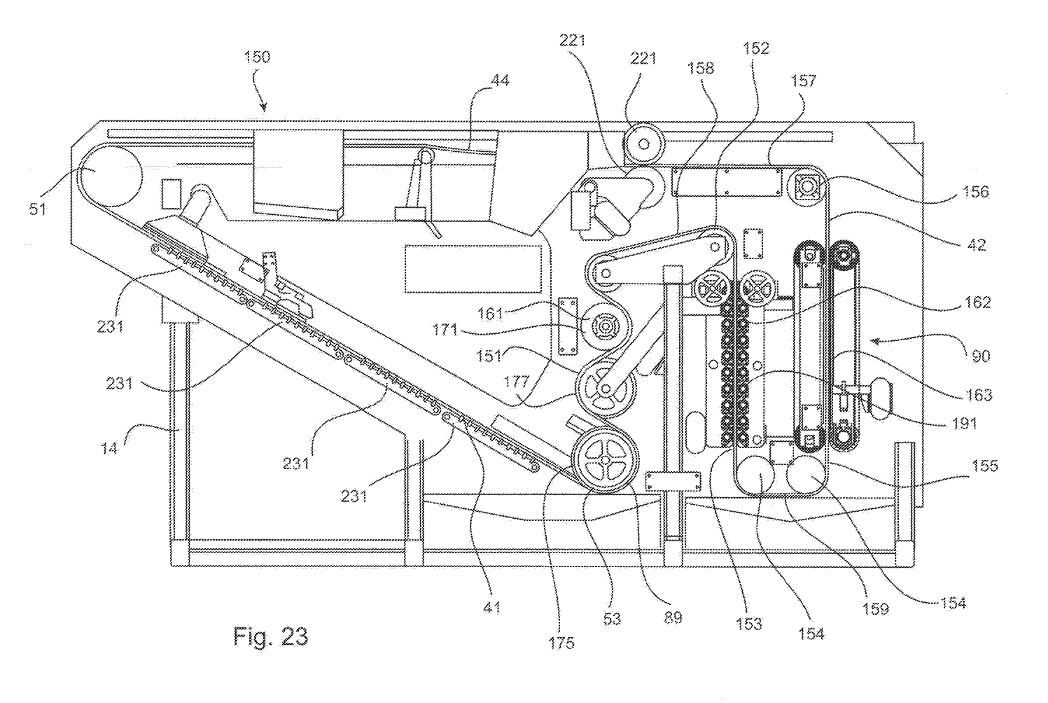

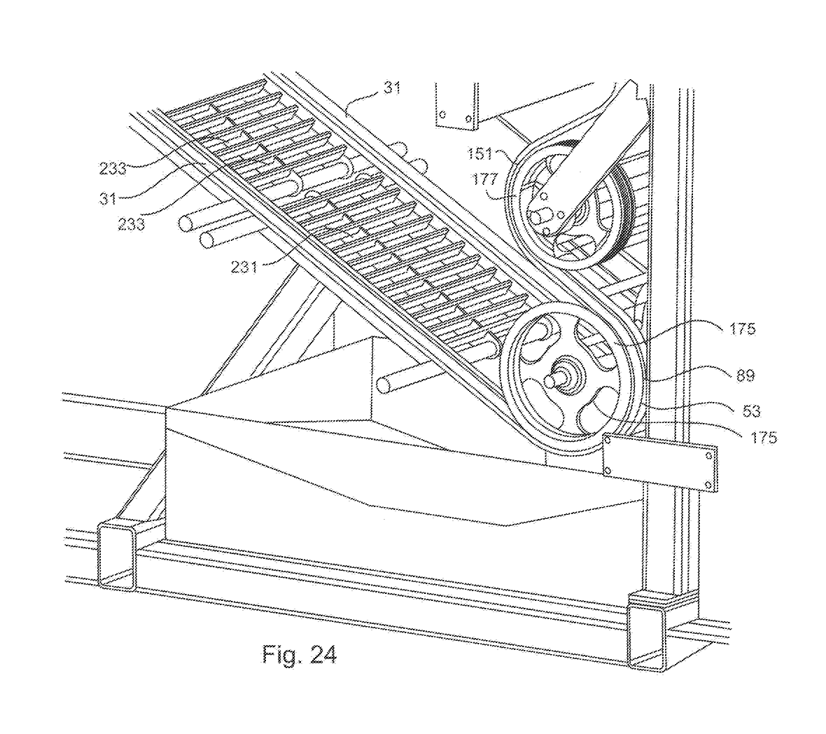

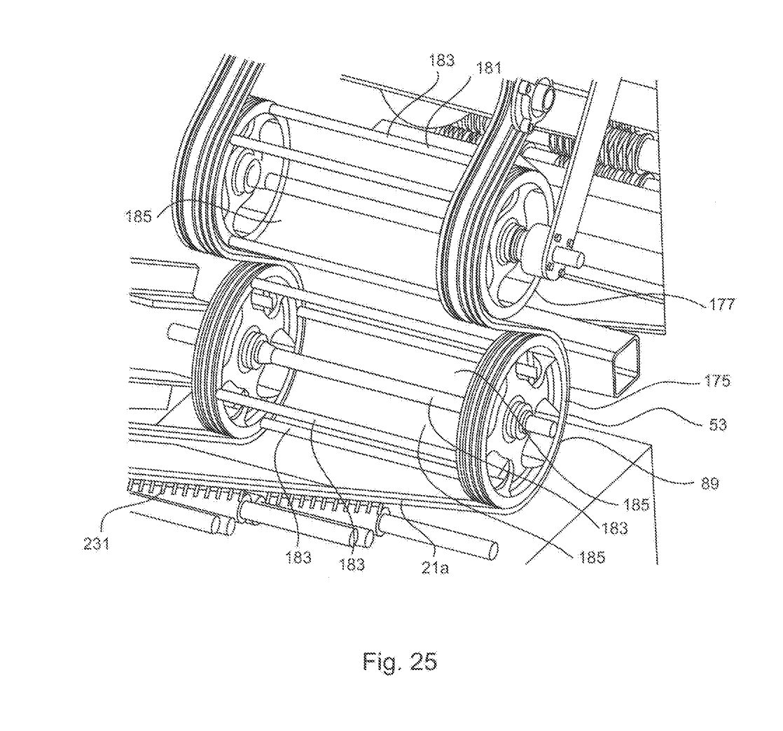

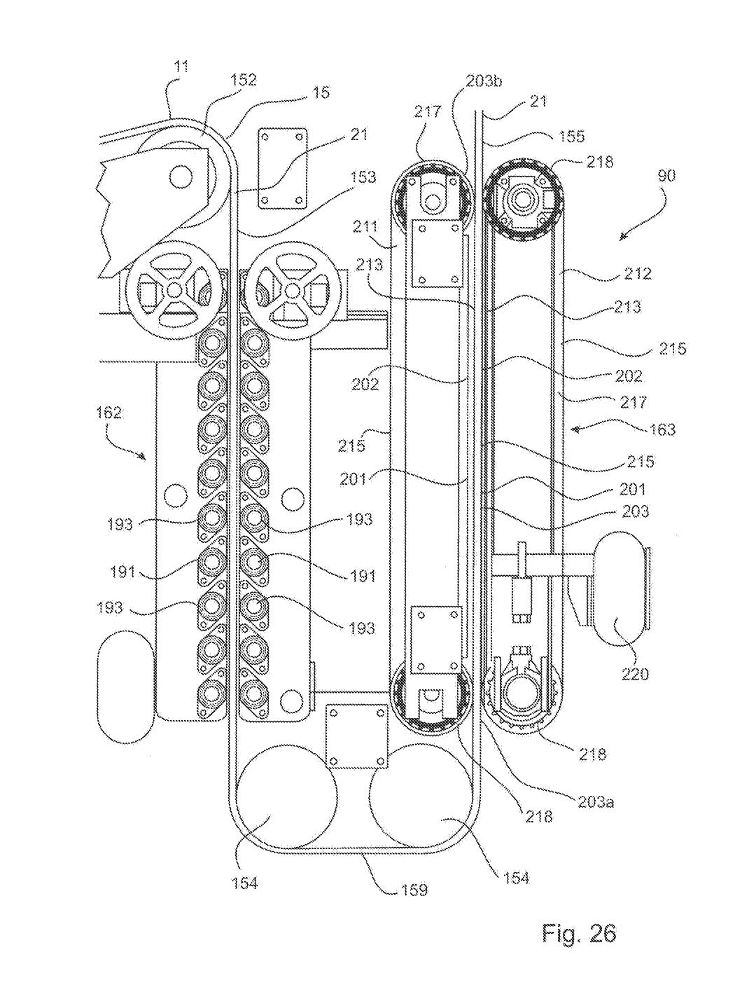

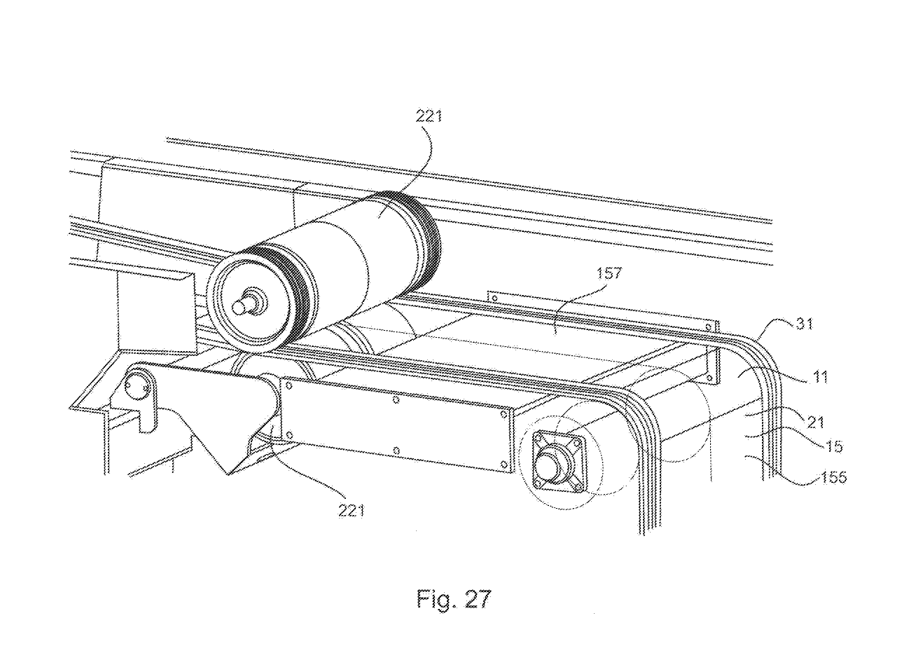

Referring now to FIGS. 23 to 27, there is shown a belt filter apparatus 150 according to a fourth embodiment. This embodiment is similar in some respects to the first embodiment and similar reference numerals are used to denote corresponding parts. In this third embodiment, the path 12 around which the endless belt structure 11 circulates comprises downwardly inclined working run 41, a further working run 42, and a generally horizontal discharge and return run 44. With this arrangement, the turn section 89 is at the bottom of the descending portion of the path 12, and the pressing station 90 within the further working run 42 is associated with a portion of the path 12 after the turn section 89.

In this embodiment, the working run 42 comprises a first ascending run section 151 a descending run section 153, second ascending run section 155, and a transition run section 157 which extends to the discharge and return run 44. The working run 42 further comprises a first bridging run section 158 between the first ascending run section 151 and the descending run section 153, and a second bridging run section 159 between the descending run section 153 and the second ascending run section 155. The further working run 42 also includes intervening turn rollers 152, 154 and 156.

The pressing station 90 comprises a first press 161 associated with the first ascending run section 151, a second press 162 associated with the descending run section 153, and a third press 163 associated with the second ascending run section 155.

The first press 161 a series of compaction rollers 171 about which the first ascending run section 151 successively passes in a serpentine manner to effect compaction of the solids cake within the tubular structure.

The path 12 passes around turn section 89 before commencing the first ascending run section 151. As with the first embodiment, the turn section 89 is defined by lower turn roller 53. In this third embodiment, turn roller 53 comprises a first squirrel cage roller 175. The first ascending run section 151 then passes around a second squirrel cage roller 177 above the first squirrel cage roller 175 before encountering the series of compaction rollers 171.

Each squirrel cage roller 175, 177 has an outer periphery 181 about which the tubular structure 21 passes. The outer periphery 181 is defined by a plurality of circumferentially spaced elements 183 with spacings between the elements 183 defining cavities 185 in the outer periphery 181. With this arrangement, the circumferentially spaced elements 183 cause contraction of successive sections of the tubular structure 21 as it advances about the rollers 175, 177 and the intervening cavities 185 accommodate corresponding radial expansion of successive sections of the tubular structure 21. The radial expansion of successive sections of the tubular structure 21 establishes a series of pockets within the tubular structure as it turns about each roller 175, 177. This action is somewhat akin to a peristaltic action in that there is radial contraction and radial expansion of successive sections of the tubular structure 21, although the thickened solids cake within the tubular structure is not pumped along the tubular structure. Rather, the thickened solids cake continues to advance with the tubular structure 21 and move upwards with the tubular structure 21 (instead of falling down the tubular structure after having passed through the two squirrel cage rollers 175, 177), the radial expansion merely accommodating material displaced as a result of the radial contraction arising from engagement with the squirrel cage roller 175, 177. In particular, the thickened solids cake is trapped in the pockets established in the tubular structure by the circumferentially spaced elements of each of the squirrel cage rollers 175, 177 and thus is forced to continue to advance with the tubular structure 21.

The second press 162 is adapted to subject the tubular structure 21 to compression (hereinafter referred to as primary compression) to further expel liquid from the compacted solids cake within the tubular structure 21. The second press 162, comprises a series of compression rollers 191 between which the descending run section 153 passes to effect compression of the compacted solids cake to further expel liquid therefrom.

The series of compression rollers 191 comprises a plurality of rollers 193 arranged in pairs, with the descending run section 153 passing between each respective pair to be compressed thereby.

From the second press 162, the tubular structure 21 advances to the third press 163, passing around intervening turn rollers 154, each of which is configured as a squirrel cage roller of the type described above.

The third press 163 is adapted to subject the tubular structure 21 to further compression (hereinafter referred to as secondary compression) to further expel liquid from the compacted and compressed solids cake within the tubular structure 21.

The third press 163 is configured to squeeze the tubular structure 21 and thus extract any available remnant liquid from the compacted and compressed solids cake contained therein.

The third press 163 compose two press portions 201 defining press faces 202 disposed in opposed, spaced apart relation to define a pressing zone 203 through which the tubular structure 21 can pass. The tubular structure 21 is drawn through the pressing zone 203 between the two press portions 201, with the opposed press faces 202 exerting a pressing action on the tubular structure as it is drawn though the pressing zone. The tubular structure 21 is drawn through the pressing zone 203 as it circulates around the path 12.

The pressing zone 203 between the two press portions 201 is configured to contract progressively in the direction of travel of the tubular structure 21 through the pressing zone so as to progressively increase the pressing action on the tubular structure as it advances through the pressing zone, in the arrangement shown, the contraction is for substantially the entire pressing zone and is represented by the press faces 202 tapering towards each other along the pressing zone 203. With this arrangement, the pressing action comprises a reactionary pressing action in the sense that the two press portions 201 do not undergo inward movement with respect to each other to effect the pressing action, but rather the pressing action arises from interaction between the two press portions 201 and the portion of the tubular structure 21 being compressed as it is drawn through the pressing zone. In other words, the reaction of the tubular structure 21 acting on each press portion 201 as the tubular structure 21 moves through the narrowing pressing zone 203 exerts the compressive force on the tubular structure to express any available remnant liquid from the compacted and compressed solids cake contained in the tubular structure 21.

In this embodiment, the press portions 201 comprise an arrangement involving two cyclically movable structures 211, 212 each having an inner run 213 and an outer run 215, with the two cyclically movable structures being so positioned that the two inners runs comprise the press portions 210. In the arrangement shown, the cyclically moveable structures 211, 212 comprise two endless bands 217 passing around end rollers 218. The two endless bands 217 are disposed in spaced apart relation, with the inner runs 213 cooperating to define a gap 215 which represents the pressing zone 203 in which the tubular structure 21 is subjected to compressive action. The cyclically movable structures 211, 212 are perforated or otherwise configured to allow liquid extracted as a result of the pressing action to flow away from the press zone. By way of example, each endless band 217 may be formed of mesh material, with pores in the mesh providing perforations to allow liquid extracted as a result of the pressing action to flow away from the press zone. Each endless band may comprise a metal endless band, including in particular a steel endless band.

The pressing zone 203 defined by the gap 215 between the inner runs 213 has an entry end 203a through which the tubular structure continuously moves into the pressing zone and an exit end 203b from which the tubular structure continuously leaves the pressing zone as the belt portion 15 circulates around the path 12. The pressing zone 203 narrows in the direction from the entry end 203a to the exit end 203b by reason of the tapering press faces 202, as previously described.

While not shown in the drawings, each inner run 213 is supported along its length by a support structure. The support structures are configured to guide the inner runs 213 in a manner inducing the necessary tapering in the support faces 202 defined by the inner runs. In one arrangement, each support structure may comprise a support face formed of low-friction material. The low-friction material may be of any suitable type, such as a thermoplastic polyethylene. Ultra-high-molecular-weight polyethylene (UHMWPE) is believed to be particularly suitable. In another arrangement, each support structure may comprise a series of support rollers. Still other arrangements of the support structures are also possible.

An adjustment mechanism 220 is provided for selectively adjusting the width of the gap 215. In the arrangement shown, the adjustment mechanism 220 is operable to move one of the cyclically movable structures 211, 212 with respect to the other.

The press portions 201 defining the pressing zone 203 need not necessarily comprise the arrangement described and illustrated, and may comprise other arrangements. By way of example, the press portions 201 may comprise platens defining press surfaces in opposed relation for exerting a pressing action on the tubular structure as it is drawn through the pressing zone. The press surfaces, or at least one of the press surfaces, may be perforated or otherwise configured to allow liquid extracted as a result of the pressing action to flow away from the press zone. The platens may be made of low friction material to facilitate sliding movement of the tubular structure in a compressed condition as it passes through the pressing zone. The low-friction material may be of any suitable type, such as a thermoplastic polyethylene. Ultra-high-molecular-weight polyethylene (UHMWPE) is believed to be particularly suitable, owing to its low coefficient of friction, resistance to abrasion, self-lubricating nature, and high resistance to most corrosive chemicals.

The transition run section 157 of the working run 42 incorporates two opposed pinch rollers 221 configured to configured to squeeze the tubular structure 21 a final time to extract any available remnant liquid from the compacted and compressed solids cake contained in the tubular structure before the latter advances to the discharge and return run 44 of the path 12.

In this fourth embodiment, the descending portion of the path 12 along which the assemble-A tubular structure 21 passes is configured to provide support for the inclined descending portion 21a of the tubular structure 21 advancing therealong, as is the case in the previous embodiments. In this fourth embodiment, the support is provided by a series of support structure 231 each configured as a wash board arrangement comprising a plurality of spaced apart ribs 233 extending transversely of the descending portion of the path 12, as shown in FIG. 23. The ribs 233 provides support for the descending portion 21a and also induce deformations locally in the descending portion 21a, thereby established the uneven bed over which material within the descending portion of the tubular structure flows.

In the embodiments described previously, each belt filter apparatus 10, 130, 150 is configured to provide a single tubular structure 21. Other embodiments, of the belt filter apparatus according to the invention may be configured to provide a plurality of tubular structures operable in side-by-side parallel relation. The use of apparatus configured to provide a plurality of tubular structures may be advantageous in certain circumstances. By way of example, such apparatus may offer large areas for processing with opening and dosing areas that are relatively small. This is due to the length relationship between a narrow tubular structure and a wide tubular structure. With a wide tubular structure there is a requirement for a disproportionately long length to open and dose the tubular structure. In contrast, a series of relatively narrow tubular structures operating in concert only requires the same birth as any one of the component small tubular structures within the series to open and dose the tubular structure. This provides packaging advantages that are not available with a large tubular structure.

The two following embodiments exhibit such arrangements involving a plurality of tubular structures operable in side-by-side parallel relation.

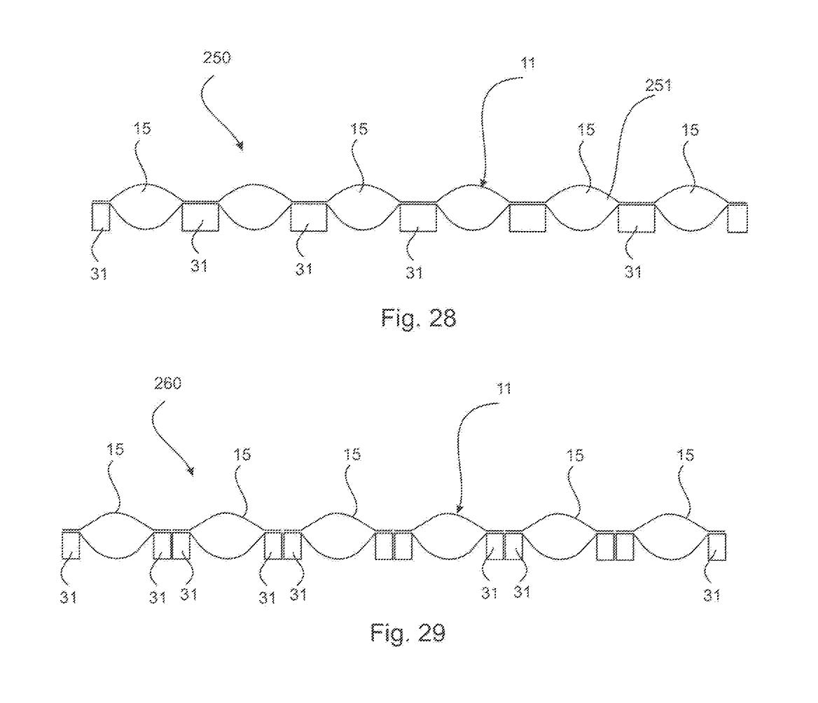

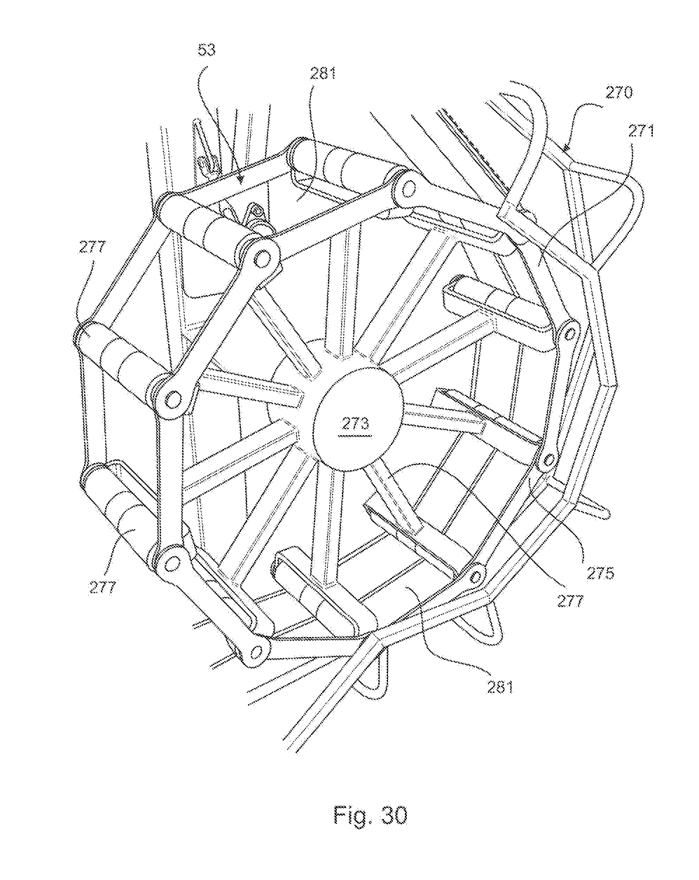

Referring now to FIG. 28, there is shown, in cross-section, an endless belt structure for a belt filter apparatus 250 according to a fifth embodiment. This embodiment is similar in some respects to the previous embodiment and similar reference numerals are used to denote corresponding parts.

In the belt filter apparatus 250, the endless structure 11 comprises a plurality of belt portions 15 each adapted to be assembled into a respective one of the tubular structures 21. Each belt portion 15 is connected to, and supported between two funicular elements 31. Further, the belt portions 15 are connected one to another to provide a common assembly 251. With this arrangement, adjacent belt portions 15 may share a common funicular element 31 disposed therebetween.

With this arrangement, there are a plurality of funicular elements 31 spaced at intervals across the common assembly 251. While not shown in FIG. 28, the roller structures over and around which the funicular elements 31 pass would comprise a corresponding number of wheels (similar to wheels 14 supported on a shaft 16 in the first embodiment).

While not shown in the drawing, each belt portion 15 would be constructed in a similar fashion to the single belt portion 15 of preceding embodiments in that it would comprise two opposed longitudinal edges and two interconnected longitudinal sections, with one longitudinal section being spit to provide the two longitudinal edges, as well as a connection means for releasably connecting the two longitudinal edges of the belt portion together so as to form a tubular structure 21.

Referring now to FIG. 29, there is shown, in cross-section, an endless belt structure for a belt filter apparatus 260 according to a sixth embodiment. This embodiment is similar in some respects to the previous embodiment and similar reference numerals are used to denote corresponding pads.

In the belt filter apparatus 260, the endless structure 11 comprises a plurality of belt portions 15 each adapted to be assembled into a respective one of the tubular structures 21. Each belt portion 15 is connected to, and supported between, two funicular elements 31. In this embodiment, the heft portions 15 exist separately of each other, with each belt portion supported between discrete funicular elements 31. In other words, each belt portion 15 and its associated funicular elements 31 constitute an independent unit. This arrangement is advantageous in that it facilitates replacement of any one of the belt portions 15 without necessitating replacement of other belt potions at the same time.

While not shown in FIG. 29, the roller structures over and around which the funicular elements 31 pass would comprise a corresponding number of wheels (similar to wheels 14 supported on a shaft 16 in the first embodiment).

In certain of the embodiments described, there was reference to the turn roller structure at turn section 89 being configured as a squirrel cage roller.

In another arrangement, the turn roller structure may be configured to present a plurality of roller elements to the turning tubular structure, with roller elements being disposed in circumferentially spaced relation and rotating independently of the speed of movement of the tubular structure. Such an arrangement is used in the seventh embodiment of the apparatus according to the invention.

Referring now to FIG. 30, there is shown part of apparatus 270 according to a seventh

embodiment. The apparatus 270 has turn roller structure 53 at turn section 89 configured as a rotatable structure 271 comprising a central hub 273 rotatably mounted on an axle (not shown) and an outer periphery 275 supported on the hub. In the arrangement shown, the outer periphery 275 is supported on the hub 273 by way of spokes 277.

The outer periphery 275 comprises a plurality of roller elements 277 disposed in circumferentially spaced relation. The roller elements 277 are rotatable independently of each, each about an axis of rotation parallel to the axis of rotation of the rotatable structure 271 (being the central axis of the axles on which the hub 273 is rotatable.

The outer periphery 275 has cavities 281. With this arrangement, the circumferentially roller elements 277 cause contraction of successive sections of the tubular structure 21 as it advances about the turn section and the intervening cavities 281 accommodate corresponding radial expansion of successive sections of the tubular structure

In one arrangement, the rotatable structure 271 may be arranged to free-wheel.

In another arrangement, the rotatable structure 271 may be adapted to be driven.

With this latter arrangement, the rotatable structure 271 may be operable to force material to move along the tubular structure 21 at a rate faster than the speed of the tubular structure. The funicular elements 31 may he used in this arrangement to guide the rotatable structure 271 and the tubular structure 21 together so that they do not get out of alignment as a result of the rotatable structure 27 being driven independently of the tubular structure.

While the present invention has been described in terms of a preferred embodiments in order to facilitate better understanding of the invention, it should be appreciated that various modifications can be made without departing from the principles of the invention. Therefore, the invention should be understood to include all such modifications within its scope.

Furthermore, it should be understood that any feature described in relation to one embodiment may, as and when appropriate, be incorporated in any other embodiment even though the feature may not have necessarily been described and illustrated in relation to that other embodiment. By way of example, the support arrangement adapted to provide support for the inclined descending portion of the tubular structure described and illustrated in several embodiments may be implemented in the first embodiment even though the latter is not described and illustrated with this feature.

Reference to positional descriptions, such as “upper”, “lower”, “top” and “bottom”, are to be taken in context of the embodiments depicted in the drawings, and are not to be taken as limiting the invention to the literal interpretation of the term but rather as would be understood by the skilled addressee.

Additionally, where the terms “system”, “device”, and “apparatus” are used in the context of the invention, they are to be understood as including reference to any group of functionally related or interacting, interrelated, interdependent or associated components or elements that may be located in proximity to, separate from, integrated with, or discrete from, each other.

Throughout this specification, unless the context requires otherwise, the word “comprise” or variations such as “comprises” or “comprising”, will be understood to imply the inclusion of a stated integer or group of integers but not the exclusion of any other integer or group of integers.

1. An apparatus for performing an operation on a fluid material to separate liquid from solid matter within the fluid material, the apparatus comprising a belt structure movable along a path, the belt structure comprising a belt portion adapted to be assembled into a movable tubular structure within which at least part of the operation is to be performed, the tubular structure being permeable to liquid for separation of liquid from solid matter within the fluid material, the tubular structure being continuously assembled at one end thereof and continuously disassembled at another end thereof during movement of the belt structure, the path including a descending portion along which the assembled tubular structure passes, the descending portion being inclined whereby at least some of the solid matter within fluid material in the tubular structure is caused to move downwardly along the descending portion under the influence of gravity to facilitate cleaning of the permeable tubular structure.

2. (canceled)

3. The apparatus according to claim 1 wherein the belt portion has longitudinal edges adapted to be connected together to assemble the movable tubular structure.

4. The apparatus according to claim 3 wherein the longitudinal edges are adapted to be releasably connected together by a slidable connector means, the slidable connector means comprising two connector elements adapted to interact with each other to provide a connection therebetween, each connector element presenting a contact face and also ridges and recesses arranged to interact with each other, the two connector elements being substantially identical in construction and configured for mating engagement.

5-7. (canceled)

8. The apparatus according to any one of the preceding claim 1 wherein the belt structure further comprises two funicular elements connected to the belt portion, the funicular elements being adapted to support the belt portion therebetween and also adapted to guide and drive the belt structure along the path.

9. (canceled)

10. The apparatus according to claim 1 wherein the belt structure comprises an endless belt structure and the path comprises an endless path about which the endless belt structure circulates, wherein the endless path incorporates guide roller structures around which the belt structure passes with the funicular elements in engagement with the guide roller structures and wherein the guide roller structures are configured to guidingly receive the funicular elements.

11. The apparatus according to claim 10 wherein the endless path incorporates guide roller structures around which the belt structure passes with the funicular elements in engagement with the wide roller structures and wherein the guide roller structures are configured to guidingly receive the funicular elements.

12-16. (canceled)

17. The apparatus according to claim 1 further comprising means for introducing fluid material on which an operation is to be performed into the tubular structure, wherein delivery of fluid material into the tubular structure is controlled to allow fluid flow downwardly along at least a section of the inclined descending portion thereby encouraging solids to move downwardly along the descending portion under the influence of gravity to establish relative movement between the solids within the tubular structure and the tubular structure itself to facilitate cleaning of the permeable tubular structure.

18. (canceled)

19. The apparatus according to claim 1 wherein the descending portion of the path along which the assembled tubular structure passes is configured to provide support for the inclined descending portion of the tubular structure advancing therealong.

20. The apparatus according to claim 19 wherein the support is configured to cause disturbance of material flow within the tubular structure and to also spreading of the material within the tubular structure. More particularly, the support is preferably configured to create turbulence in the downwards flow and spread the flow to optimise the area within the tubular structure being utilised thereby to allow the scouring process to occur and also optimise the area over which liquid can leave the tubular structure.

21. (canceled)

22. The apparatus according to any one of the preceding claim 1 wherein the arrangement is such that flow of fluid material along the inclined descending portion of the tubular structure slows towards the bottom end thereof, leading to an accumulation of solids in the bottom section, the accumulation of solids in the bottom section establishing a blockage to assist in slowing liquid flow within the tubular structure.

23. The apparatus according to claim 1 wherein the path at the bottom of the descending portion along which the assembled tubular structure passes includes a turn section configured to propagate radial expansion and contraction of successive sections of the tubular structure as it advances about the turn section, thereby assisting to convey the agglomerated material within the tubular structure around the turn section.

24. The apparatus according to claim 23 wherein the turn section is defined by a turn roller structure having an outer periphery about which the tubular structure passes, the outer periphery comprising a plurality of circumferentially spaced portions with intervening cavities therebetween.

25-26. (canceled)

27. The apparatus according to claim 1 further comprising press means for pressing the tubular structure along a portion thereof n.

28-43. (canceled)

44. The apparatus according to claim 1 further comprising a liquid removal system operable to engage the exterior of the tubular structure to cause liquid adhering thereto to be released.

45-68. (canceled)

69. A method of removal of liquids from solids in fluid material, the method comprising assembling a movable tubular structure within which at least part of the removal operation is to be performed, the tubular structure being permeable to the liquid, moving the tubular structure along a path including a descending portion, introducing the fluid material into the tubular structure whereby the fluid material flows down the descending portion, the descending portion being inclined whereby at least some of the solid matter is caused to move downwardly along the descending portion under the influence of gravity to facilitate cleaning of the permeable tubular structure.

70. The method according to claim 69 further comprising subjecting the tubular structure to a pressing action along a portion of the path after the descending portion.

71-72. (canceled)

73. The method according to claim 69 wherein delivery of fluid material into the tubular structure is controlled such that to allow fluid flow downwardly along at least a section of the inclined descending portion thereby encouraging solids to move downwardly along the descending portion under the influence of gravity to establish relative movement between the solids within the tubular structure and the tubular structure itself to facilitate cleaning of the permeable tubular structure.

74. The method according to claim 69 further comprising supporting the inclined descending portion of the tubular structure, wherein the inclined descending portion is supported in a manner to disturb material flow within the tubular structure and to also spread the material within the tubular structure.

75-80. (canceled)

81. Apparatus for performing an operation on a material, the apparatus comprising a belt structure movable along a path, the belt structure comprising a belt portion adapted to be assembled into a movable tubular structure within which at least part of the operation is to be performed, the tubular structure being continuously assembled at one end thereof and continuously disassembled at another end thereof during movement of the belt structure, the belt portion having longitudinal edges adapted to be connected together by a slidable connector means to assemble the movable tubular structure, the slidable connector means comprising two connector elements adapted to interact with each other to provide a connection therebetween, and a slider operable in conjunction with the two connector elements to move them together into engagement as the endless belt circulates around path, the slider comprising a body having two passages each configured to receive one of the connector elements, the two passages being disposed to align the connector elements in preparation for them being brought together into an interconnected condition.
